(19) United States
(12) Patent Application Publication
(10) Pub. No.: US 2003/0200300 A1
(43) Pub. Date: Oct. 23, 2003

(54) Singularly hosted, enterprise managed, plural branded application services

(75) Inventor: Daniel Joseph Melchione, Beaverton, OR (US)

Correspondence Address: KLARQUIST SPARKMAN, LLP, 121 SW SALMON STREET, SUITE 1600, PORTLAND, OR, 97204, US

(73) Assignee: Secure Resolutions, Inc.

(21) Appl. No.: 10/215,960

(22) Filed: Aug. 9, 2002

Related U.S. Application Data
(60) Provisional application No. 60/375,215, filed on Apr. 23, 2002.
(60) Provisional application No. 60/375,176, filed on Apr. 23, 2002.
(60) Provisional application No. 60/375,174, filed on Apr. 23, 2002.
(60) Provisional application No. 60/375,154, filed on Apr. 23, 2002.
(60) Provisional application No. 60/375,210, filed on Apr. 23, 2002.
(60) Provisional application No. 60/375,216, filed on Apr. 23, 2002.

(51) Int. Cl. G06F 15/173; G06F 15/16

(52) U.S. Cl. 709/223; 709/201

(57) ABSTRACT

A plurality of separate customers can enter into separate agreements with a vendor who provides application services to the customer via provider. A plurality of vendors can sell services hosted by a single application service provider to different customers. The provider vendor-brands portions of the application services supplied to a customer. The vendor-brand presentation perceived by a customer is of the vendor who contracts to provide those services to the customer. Because of the vendor-branded presentation, a specific customer may be unaware that the provider is hosting the vendor-branded application service. A data center is used to provide information about administered software, customers and vendors.

### CROSS-REFERENCE TO OTHER APPLICATIONS

This patent application claims priority to U.S. provisional patent applications Nos. Melchione et al., entitled, “Software Distribution via Stages,” No. 60/375,215; Melchione et al., entitled, “Fault Tolerant Distributed Computing Applications,” No. 60/375,176; Melchione et al., entitled, “Providing Access To Software Over a Network via Keys,” No. 60/375,174; Melchione et al., entitled, “Distributed Server Software Distribution,” No. 60/375,154; Melchione et al., entitled, “Executing Software in a Network Environment,” No. 60/375,210, and Huang et al., “Software Administration in an Application Service Provider Scenario Via Configuration Directives,” No. 60/375,216 all of which were filed on Apr. 23, 2002, and all of which are incorporated herein by reference.

### TECHNICAL FIELD

The invention relates to application services and, more particularly, to plural branded, singularly hosted software administration in an application service provider scenario.

### COPYRIGHT AUTHORIZATION

A portion of the disclosure of this patent document contains material that is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### BACKGROUND

Organizations have become increasingly dependent on computers to maintain high levels of productivity. Administering a large number of computers in an organization can be a burdensome task. The burden is further compounded when the computers are scattered throughout various locations and departments of the organization.

One particularly challenging aspect of computer administration relates to administering software on computers. It may be desirable to configure software based on a variety of circumstances. The circumstances can change over time, and circumstances can vary from one location to another or from one computer to another. Further, at some point, the software may need to be upgraded.

Tracking the configuration of a number of computers with various configurations can be overwhelming. And, in addition to tracking the configurations, changes to the configurations may be desired on a regular basis. Implementing such changes can consume inordinate amounts of resources. Accordingly, improvements in the field of software administration are needed.

### SUMMARY

The above issues can be problematic to administrators, whether they manage a small network or an enterprise having thousands of computers spread over multiple locations.

In various embodiments described herein, software administration can be achieved via an application service provider scenario. For example, configuration directives for a set of computers can be collected via an application service provider scenario. Agent software running at the computers can periodically contact a data center having access to a database in which the configuration directives are stored.

Responsive to communications from agents at the computers, the configuration directives can be implemented. A variety of software administration configuration directives can be implemented. For example, settings or preferences related to administered software can be configured; software designated as to be installed at a computer can be installed at a computer.

A data center can provide software administration services via an application service provider scenario for a plurality of customers (e.g., governments, organizations, or enterprises). For example, a plurality of separate customers can enter into separate agreements with a vendor who provides application services to the customer via an application service provider. Or, a plurality of vendors can sell services hosted by a single application service provider to different customers. The provider vendor-brands portions of the application services supplied to a customer. The vendor-brand presentation perceived by a customer is of the vendor who contracts to provide those services to the customer. Because of the vendor-branded presentation, a specific customer may be unaware that the provider is hosting the vendor-branded application service.

A customer may purchase provider-hosted application services via plural vendors. For example, a customer may purchase antivirus application services from one vendor and tax application services from another vendor. The vendor-branded application service perceived by a customer contains the vendor-brand of the vendor who contracts to provide those provider-hosted application services to the customer.

Plural vendors may offer the same application services to customers. For example, a software developer may offer plural vendors a selection of application services packages. In turn, the vendor can select to offer some or all of these application services packages to their customers. In such a case, the provider will host the application services packages for customers of the vendor. The vendor-branded application service perceived by a customer contains the vendor-brand of the vendor who contracts to provide the provider-hosted application services to the customer. In another case, a vendor may be the software developer offering other vendors a selection of application services packages. In one other case, the provider may be the software developer offering vendors a selection of application services packages. In any such case, when a vendor decides to offer a selected application service (or several) to their customers, the provider hosts the application services for customers of the vendor. In such a case, the vendor-branded application service perceived by a customer contains the vendor-brand of the vendor who contracts to provide those provider-hosted application services to the customer. Of course, a software developer (whether or not they are also a vendor or the provider) may elect to restrict who is able to offer their application services.

To facilitate creating agreements between customers and a vendor, a provider-hosted network resource (e.g., web pages) is available that allows a customer to originate an automated agreement with a vendor offering provider-hosted application services. This feature helps save time for the vendor and the customer.

To facilitate software administration, a customer is provided with a network accessible resource for selecting application services and designating which customer computers utilize which selected application services. The software administration resource is vendor-branded. In one case, a customer administrator places customer computers into named groups, and specifies application services for the named groups. In this way, software can be administered for a large number of computers more easily.

To facilitate creating application services hosting agreements between potential vendors and the provider, a provider-hosted network resource (e.g., web pages) is available that allows a potential vendor to originate an automated agreement with the provider. A vendor is subsequently able to offer potential customers vendor-branded application services hosted by the provider. This feature helps save time for the vendor and the provider.

To facilitate receiving application services packages, a provider-hosted network resource (e.g., web pages) is available that allows a software developer, to originate an automated agreement with the provider. Upon uploading an application services package, a software developer is subsequently able to offer potential application service packages to vendors for consideration, including a set of terms and conditions.

To facilitate accepting application services packages for offering by vendors, a provider-hosted network resource (e.g., web pages) is available that allows vendors to browse available application services packages and to accept software developer offered terms and conditions for a selected application services package. Upon accepting an application services package, an applications service is automatically placed in a set of directories for offering by the vendor. In one case, software designed to run locally is compiled with vendor-branded resources before being placed in a directory.

In one case, a data center provides information about which customers are associated with which vendors. This association information can help the provider limit what customers a vendor is able to obtain information about. A customer who enters into separate agreement with two vendors, will have information available to them related to both vendor services. In such a case, each vendor will be provided information only related to their agreements with the customer.

In another case, a data center provides information about which customer computers are associated with which vendors. This association information can help the provider limit what computers a customers is able to configure or obtain information about. A customer who enters into separate agreement with two vendors, will have information related to both vendor services. In such a case, each vendor will be provided information only related to their agreements with the customer.

In one case, administered software may be downloaded and run at a customer computer. In other cases, administered software represents some portion of administered software in processing communication with other administered software residing on other customer computers or at the provider. In another case, administered software may run at the provider with only a thin client (e.g., a web browser) running at a customer computer (e.g., displaying administered software output). All these cases, represent examples of provider-hosted application services.

In certain described examples, the software being administered is anti-virus software. New releases of anti-virus software can be automatically provided according to the software administration directives set by a customer administrator. In some case, administered software includes an agent that polls the data center to obtain administered software updates.

In one case, one or plural databases support revenue calculations between associated parties. Revenue collection is also supported which may be automated.

Additional features and advantages will be made apparent from the following detailed description of illustrated embodiments, which proceeds with reference to the accompanying drawings.

### BRIEF DESCRIPTION OF THE DRAWINGS

FIG. 1 is an illustration of an exemplary application service provider scenario.

FIG. 2 is an illustration of an exemplary arrangement by which software administration can be accomplished via an application service provider scenario.

FIG. 3 depicts an exemplary user interface by which software administration can be accomplished in an application service provider scenario.

FIG. 4 illustrates an exemplary business relationship accompanying an application service provider scenario, such as that shown in FIG. 1 or 2.

FIG. 5 illustrates another exemplary business relationship accompanying an application service provider scenario, such as that shown in FIG. 1 or 2.

FIG. 6 illustrates an exemplary system where plural software types can be administered in an application provider scenarios.

FIG. 7 shows an exemplary system by which software can be administered via an application service provider scenario.

FIG. 8 shows an exemplary system by which software can be administered via a plural vendor application service provider scenario.

FIG. 9 is a flow chart showing an exemplary method of incorporating software functionality into a system by which the software can be administered via an application service provider scenario.

FIG. 10 is a flow chart depicting an exemplary method for accomplishing software administration in a vendor-branded application service provider scenario.

FIG. 11 is a flow chart depicting an exemplary method for accomplishing software administration in a vendor-branded application service provider scenario.

FIG. 12 is an exemplary arrangement involving anti-virus software.

FIG. 13 is an arrangement for providing server support for plural vendor-branded application services.

FIG. 14 is an illustration of how directories at a data center are used to support plural vendor branding.

FIG. 15 is an example partial view of a database table containing customer information and vendor association.

FIG. 16 is a screen shot showing an exemplary user interface for manipulating groups.

FIG. 17 is a screen shot showing an exemplary user interface for manipulating policies.

FIG. 18 is a screen shot showing an exemplary user interface for manipulating configuration directives related to an agent.

FIG. 19 is a screen shot showing an exemplary user interface for manipulating configuration directives related to virus infection resolution.

FIG. 20 is a screen shot showing an exemplary user interface for manipulating configuration directives related to scheduled tasks.

FIGS. 21A-21J show an exemplary database schema for use with an implementation of technologies described herein.

FIGS. 22A-22B show another exemplary database schema for use with an implementation.

### DETAILED DESCRIPTION

### Application Service Provider Overview

The embodiments described herein can be implemented in an application service provider scenario. In particular embodiments, software administration can be accomplished via an application service provider scenario.

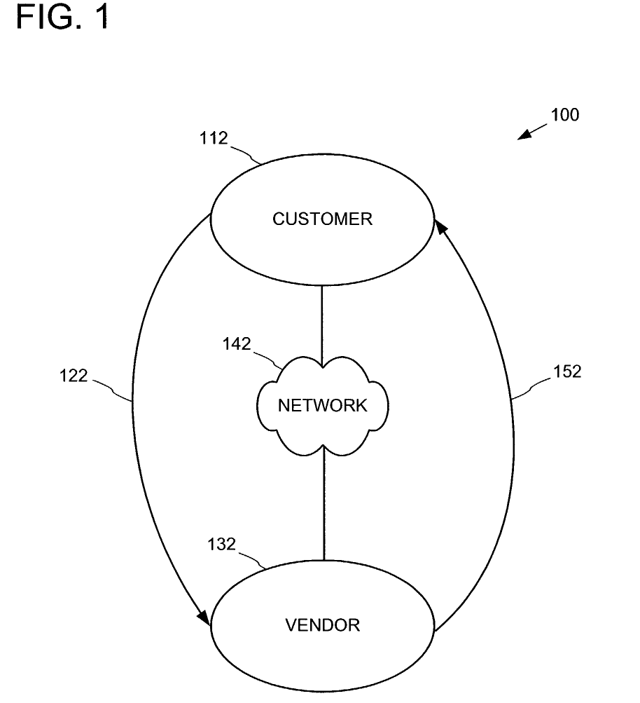

An exemplary application service provider scenario 100 is shown in FIG. 1. In the scenario 100, a customer 112 sends requests 122 for application services to an application service provider vendor 132 via a network 142. In response, the vendor 132 provides application services 152 via the network 142. The application services 152 can take many forms for accomplishing computing tasks related to a software application or other software.

To accomplish the arrangement shown, a variety of approaches can be implemented. For example, the application services can include delivery of graphical user interface elements (e.g., hyperlinks, graphical checkboxes, graphical pushbuttons, and graphical form fields) which can be manipulated by a pointing device such as a mouse. Other application services can take other forms, such as sending directives or other communications to devices of the vendor 132.

To accomplish delivery of the application services 152, a customer 112 can use client software such as a web browser to access a data center associated with the vendor 132 via a web protocol such as an HTTP-based protocol (e.g., HTTP or HTTPS). Requests for services can be accomplished by activating user interface elements (e.g., those acquired by an application service or otherwise) or automatically (e.g., periodically or as otherwise scheduled) by software. In such an arrangement, a variety of networks (e.g., the Internet) can be used to deliver the application services (e.g., web pages conforming to HTML or some extension thereof) 152 in response to the requests. One or more clients can be executed on one or more devices having access to the network 142. In some cases, the requests 122 and services 152 can take different forms, including communication to software other than a web browser.

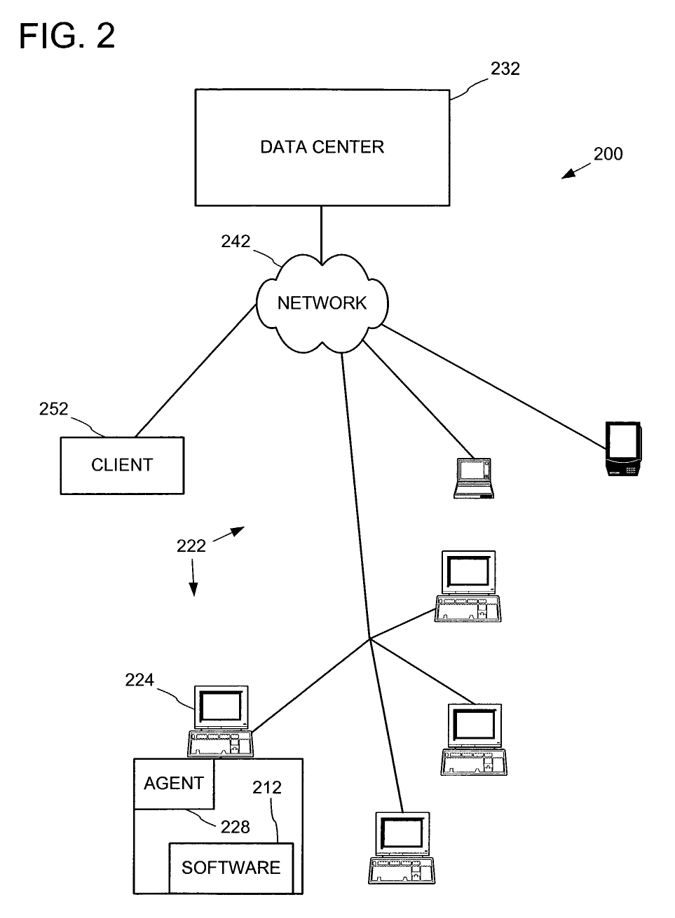

The technologies described herein can be used to administer software (e.g., one or more applications) across a set of administered devices via an application services provider scenario. Administration of software can include software installation, software configuration, software management, software distribution, software licensing functions, software acquisition, or some combination thereof. FIG. 2 shows an exemplary arrangement 200 whereby an application service provider provides services for administering software (e.g., administered software 212) across a set of administered devices 222. The administered devices 222 are sometimes called “nodes.”

In the arrangement 200, the application service provider provides services for administrating instances of the software 212 via a data center 232. The data center 232 can be an array of hardware at one location or distributed over a variety of locations remote to the customer. Such hardware can include routers, web servers, database servers, mass storage, and other technologies appropriate for providing application services via the network 242. Alternatively, the data center 232 can be located at a customer's site or sites. In some arrangements, the data center 232 can be operated by the customer itself (e.g., by an information technology department of an organization).

The customer can make use of one or more client machines 252 to access the data center 232 via an application service provider scenario. For example, the client machine 252 can execute a web browser, such as Microsoft Internet Explorer, which is marketed by Microsoft Corporation of Redmond, Wash. In some cases, the client machine 252 may also be an administered device 222.

The administered devices 222 can include any of a wide variety of hardware devices, including desktop computers, server computers, notebook computers, handheld devices, programmable peripherals, and mobile telecommunication devices (e.g., mobile telephones). For example, a computer 224 may be a desktop computer running an instance of the administered software 212.

The computer 224 may also include an agent 228 for communicating with the data center 232 to assist in administration of the administered software 212. In an application service provider scenario, the agent 228 can communicate via any number of protocols, including HTTP-based protocols.

The administered devices 222 can run a variety of operating systems, such as the Microsoft Windows family of operating systems marketed by Microsoft Corporation; the Mac OS family of operating systems marketed by Apple Computer Incorporated of Cupertino, Calif.; and others. Various versions of the operating systems can be scattered throughout the devices 222.

The administered software 212 can include one or more applications or other software having any of a variety of business, personal, or entertainment functionality. For example, one or more anti-virus, banking, tax return preparation, farming, travel, database, searching, multimedia, security (e.g., firewall) and educational applications can be administered. Although the example shows that an application can be managed over many nodes, the application can appear on one or more nodes.

In one example, the administered software 212 includes functionality that resides locally to the computer 224. For example, various software components, files, and other items can be acquired by any of a number of methods and reside in a computer-readable medium (e.g., memory, disk, or other computer-readable medium) local to the computer 224. The administered software 212 can include instructions executable by a computer and other supporting information. Various versions of the administered software 212 can appear on the different devices 222, and some of the devices 222 may be configured to not include the software 212.

In another example, some administered software 212 may be downloaded and run at an administered device 212. Other administered software 212 may represent some portion of a distributed application in processing communication with other portions of a distributed application residing on other administered devices or the provider. Other administered software may run at the provider with only a thin client (e.g., a web browser) running at an administered device 222. All these cases, represent examples of provider-hosted application services.

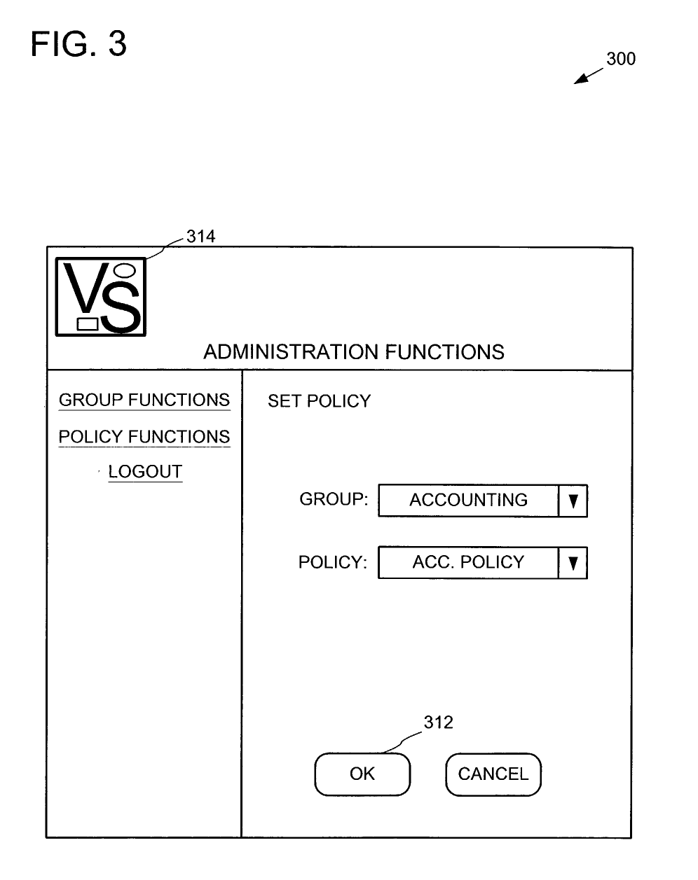

FIG. 3 shows an exemplary user interface 300 presented at the client machine 252 by which an administrator can administer software for the devices 222 via an application service provider scenario. In this example, the interface presented at the client carries a vendor branding indication 314. Using an interface of this type, one or more directives can be bundled into a set of directives called a “policy.” In the example, an administrator is presented with an interface by which a policy can be applied to a group of devices (e.g., a selected subset of the devices 222). In this way, the administrator can control various administration functions (e.g., installation, configuration, and management of the administered software 212) for the devices 222. In the example, the illustrated user interface 300 is presented in a web browser via an Internet connection to a data center (e.g., as shown in FIG. 2) via an HTTP-based protocol.

Activation of a graphical user interface element (e.g., element 312) can cause a request for application services to be sent. For example, application of a policy to a group of devices may result in automated installation, configuration, or management of indicated software for the devices in the group.

In the examples, the data center 232 can be operated by an entity other than the application service provider vendor. For example, the customer may deal directly with the vendor to handle setup and billing for the application services. However, the data center 232 can be managed by another party, such as an entity with technical expertise in application service provider technology.

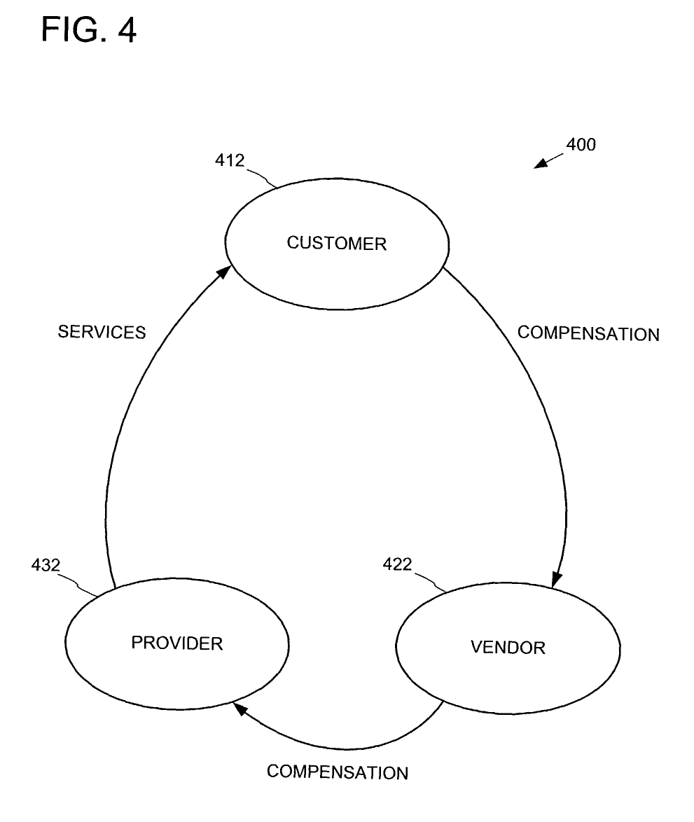

The scenario 100 (FIG. 1) can be accompanied by a business relationship between the customer 112 and the vendor 132. An exemplary relationship 400 between the various entities is shown in FIG. 4. In the example, a customer 412 provides compensation to an application services provider vendor 422. Compensation can take many forms (e.g., a monthly subscription, compensation based on utilized bandwidth, compensation based on number of uses, or some other arrangement (e.g., via contract)). The provider of application services 432 manages the technical details related to providing application services to the customer 412 and is said to “host” the application services. In return, the provider 432 is compensated by the vendor 422.

The relationship 400 can grow out of a variety of situations. For example, it may be that the vendor 422 has a relationship with or is itself a software development entity with a collection of application software desired by the customer 412. The provider 432 can have a relationship with an entity (or itself be an entity) with technical expertise for incorporating the application software into an infrastructure by which the application software can be administered via an application services provider scenario such as that shown in FIG. 2.

Although not shown, other parties may participate in the relationship 400. For example, network connectivity may be provided by another party such as an Internet service provider. In some cases, the vendor 422 and the provider 432 may be the same entity. It is also possible that the customer 412 and the provider 432 be the same entity (e.g., the provider 432 may be the information technology department of a corporate customer 412).

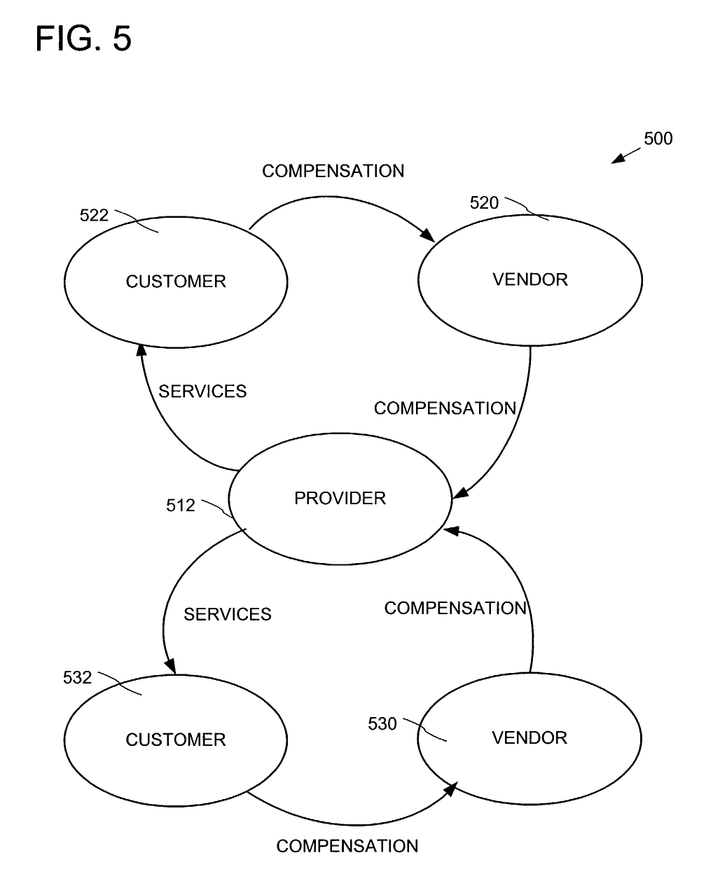

In another scenario, a single provider hosts application services for plural vendors. As shown in FIG. 5, a vendor 520 maintains relationships with certain customers 522, and those customers 522 are provided application services by the provider 512. Another vendor 530 maintains a relationship with certain customers 532, and those customers 532 are provided application services by the same provider 522. Of course, a given customer can be the customer of plural vendors. In such a case, both vendors may provide application services to the customer via the provider 512.

A vendor-branded presentation or indication includes at least one instance of a graphical or textual indication (e.g., icon, banner, text, image, etc.) on a customer computer terminal of at least one of the vendor's name, contact information, indication of source of origin, trademark, trade dress, servicemark, copyright, video, audio, look and feel, or etc. The indication may rarely be manifested in some cases. For example, the user of an administered device running antivirus software, may be unaware of the software's activity for weeks or months at a time, and only become aware when the software sends a message to the computer terminal indicating a virus was captured. In other cases, the vendor-branded presentation is often perceivable.

### EXAMPLE 1

Exemplary System Overview

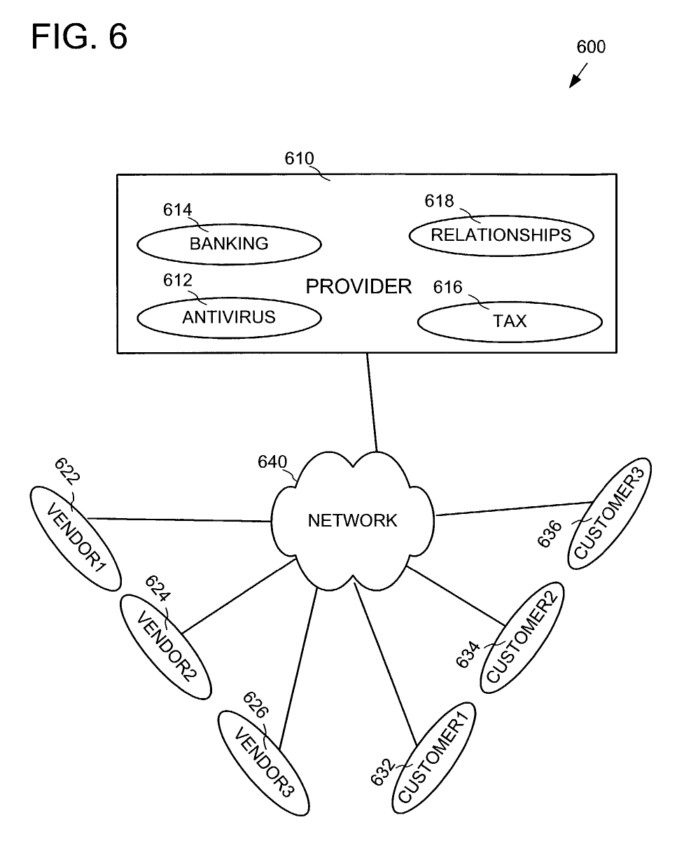

As previously mentioned, plural types of administered software can be hosted and or distributed by the provider. As shown in FIG. 6, a single provider 610 may host banking software 614, antivirus software 612, tax preparation software 616, and many other types of software. In one scenario a given vendor 622 offers banking 614 software to a customer 632. In such a scenario, the customer is provided banking software 614 by the provider 610 in an application provider arrangement over a network 640.

In such a scenario, the provider maintains records of the relationship 618 between the vendor 622, the customer 632, and the banking software 614. In such a case, the vendor 622 has relationships with another (or plural other) customer 634 being administered banking software 614 by the single provider 610, and the provider maintains an association of relationships 618 between that vendor 622 and the plural customers 632, 634. In such a scenario, the vendor can access the relationship information 618 in order to determine information about that vendor's customers or the software under administration for the customers by the provider.

In this scenario, another given vendor 624 offers antivirus software 612 to a customer 636. In this scenario, the provider maintains records of the relationship 618 between the vendor 624, the customer 636, and the antivirus software 612. In such a case, the vendor 624 has relationships with another (or plural other) customer 632 being administered antivirus software 612 by the single provider 610, and the provider maintains an association of relationships 618 between that vendor 622 and the plural customers 632, 634. In such a scenario, the vendor can access the relationship information 618 in order to determine information about that vendor's customers or the software under administration.

While not required, a vendor 626 may offers plural software types 614, 616 to a customer 634. In this scenario, the provider maintains records of the relationship 618 between the vendor 626, the customer 636, and the plural software types 614, 616. In such a case, the vendor 626 has relationships with another (or plural other) customer 636 being administered one or more software types by the single provider 610, and the provider maintains an association of relationships 618 between that vendor 622 and the plural customers 632, 634. In such a scenario, the vendor can access the relationship information 618 in order to determine information about that vendor's customers or the software under administration for the customers by the provider.

### EXAMPLE 2

Exemplary Customer Data Maintenance and Administration

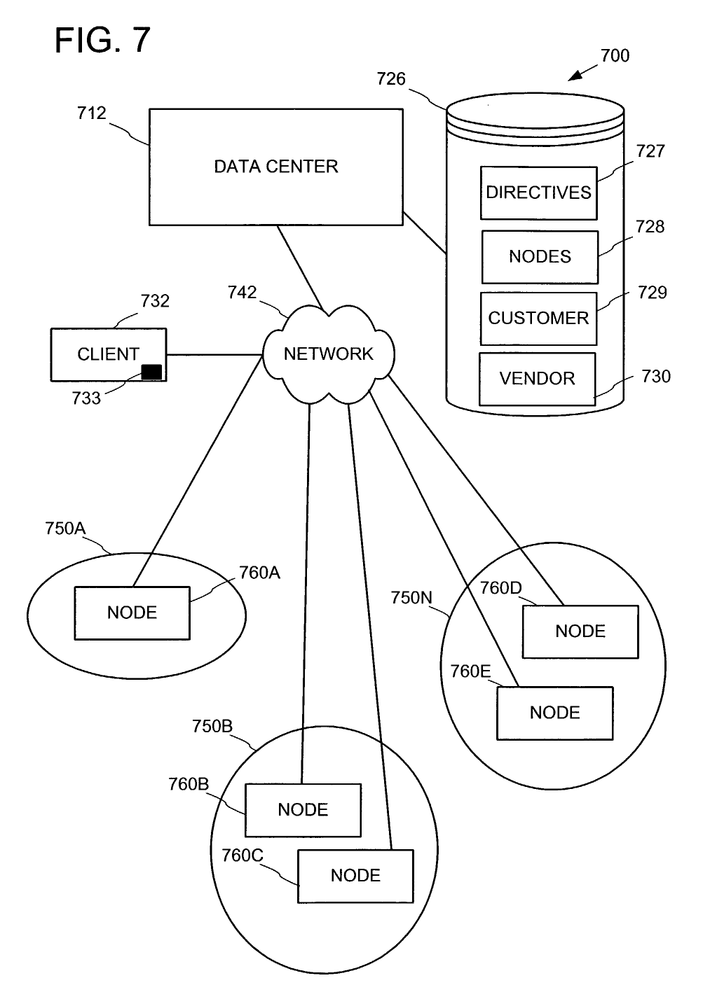

FIG. 7 depicts an overview of an exemplary system 700 by which software can be administered at a plurality of nodes for a given customer, as provided by the provider for a given vendor. In the example, a data center 712 provides software administration services for the nodes 760A, 760B, 760C, 760D, and 760E for the given customer.

The data center 712 keeps a record of software under administration for a given customer 729, directives and nodes in a database 726 (e.g., via the directives table 727 and the nodes table 728). The configuration directives in the database 726 can be associated with one or more of the nodes in the database 726. Other tables can be included, such as a groups database table or a policies database table. In one embodiment, this information can distinguish software administration for a customer at the level of node granularity.

In cases when a customer is subscribing to software offered by two or more vendors via the provider, this distinction is maintained in the data center. In one embodiment, the customer 729 is assigned a unique data record identifier for each vendor 730. In another embodiment, the customer maintains the same customer identifier for plural vendors, but a unique vendor identifier distinguishes between vendor accessible information 730. Other distinctions for record associations are known in the database arts.

A client computer 732 accesses the data center 712 via an application service provider scenario. For example, an HTTP-based protocol can be used by which a browser can access the data center 712. In this way, the data center 712 can be accessed by a client computer 732, even if a firewall blocking non-HTTP-based communications is situated between the two. In one such scenario, the provider hosts a vendor specific domain name (e.g. www.vendorname.com) which resolves to the provider. The provider identifies requests received via the vendor specific domain name, and returns a vendor-branded presentation. In such a case, the client computer 732 maybe unaware that the vendor domain is provider-hosted, because the provider returns a vendor-branded presentation to the client (e.g. FIG. 3, item 314). Thus the vendor maintains a vendor-branded presence without maintaining a separate provider infrastructure.

A user (e.g., an administrator) at the client computer 732 can provide indications of software administration and configuration directives to be associated with the nodes, and the indications are recorded in the database 726. The nodes 760A, 760B, 760C, 760D, and 760E being administered can be placed into one or more named logical groups 750A, 750B, and 750N.

The nodes can include agent software that periodically communicates with the data center 712. During such communications, the configuration directives stored in the database 726 can be implemented. For example, software administration commands, parameters, and software can be sent to an agent for use at a node. Further details relating to configuration directives can be found in Melchione et al., U.S. Provisional Application No. 60/375,216, filed Apr. 23, 2002, entitled “Software Administration in an Application Provider Scenario Via Configuration Directives.”

The illustrated system can use the Internet for the network 742. Also, communication between the nodes and the data center 712 can be performed via an application service provider scenario (e.g., via the Internet or some other network).

The described administrator at the client computer 732, may be an employee or agent of the customer (customer administrator). Further, the administrator may also be an agent or employee of the vendor, an agent or employee of the provider, or a third party administrator working under the direction of the customer or vendor.

### EXAMPLE 3

Exemplary Vendor-Branded Software in an ASP Scenario

As previously discussed, administered software is provided for use at an administered device by a customer administrator through a client interface (e.g., FIG. 7, 732). In one example, a customer administrator with the proper password, can conduct software administration for a set of administered devices for a customer from any networked computer. In a simple case, a customer may have only one or two administered devices which are also used by the customer administrator. In more typical cases, a customer may have many administered devices possibly spread out geographically and/or located on different networks.

In one example, an administered devices subsequently makes a network request for application services. If the administered device is identifiable by the provider as an administered device (according to the software administration directives at the data center), the provider will provide administered software according to the configuration directives set by the customer administrator.

As previously described, a node (administered device) is associated with a customer identifier which is associated with a vendor in a data center. In one example, this association information is used by the provider, to provide vendor-branded administered software to an administered device. The provided administered software may include in one or more graphical user interfaces provided to the administered device, a vendor-branded indication identifying the associated vendor. In one such case, a customer administrator and/or an administered device user encounters a vendor-branded look and feel while the infrastructure is maintained by a provider.

### EXAMPLE 4

Software Ownership and Branding

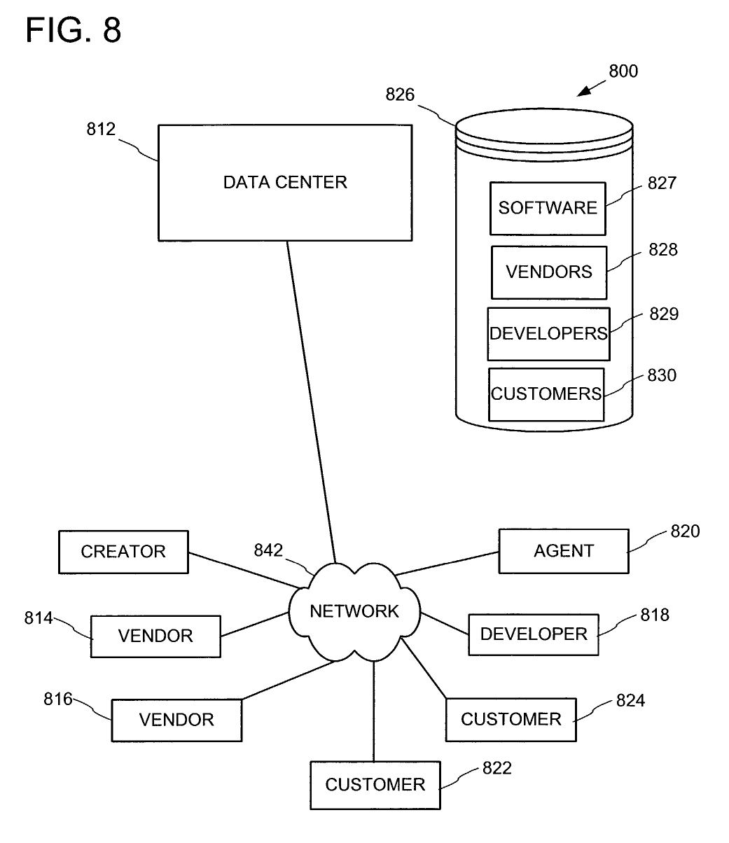

In FIG. 8, an arbitrary piece of software 827 can be incorporated into an application service provider scenario 800. The software may have been developed by a vendor 814, the provider, a customer 822, or anyone else. The software developer 818 may determine that it is feasible to offer the software to others through the provider-hosted infrastructure 800. An agent 820, on behalf of the developer, may also be participating in the scenario.

In one example, the developer may enter the network marketplace domain as a provider-hosted vendor 828. The developer would become a provider-hosted vendor (e.g., FIG. 6, 626). The new vendor 814 would up-load the software via the network 842 and administered devices of customers 830 using the software would be presented with the vendor-branded software.

In another example, the developer 818 may determine that the arbitrary software 827 is not feasible to be marketed separately from other software, or the developer may determine that a vendor, or multiple vendors may be better situated to market the software. In such a case, the software is uploaded to the provider, and offered by one or more vendors 828 to their associated customers 830.

In another example, a developer may be a vendor 814 but may also allow other vendors 828 to offer the software. In such a case, a first customer 824 of a first vendor 814 would see the vendor branding of the first vendor on a presentation of the software, while a second customer 824 of a second vendor 816 would see the vendor branding of the second vendor on a presentation of the software.

In another example, a data center 812 would provide a series of a developer administration functions according to an application provider scenario 800. In one such example, a developer is provided via a web browser, a series of provider-hosted web pages. The web pages would allow the developer to administer up-loading the software 827 to the data center 812, and to offer the software to a vendor(s) with the intention of having the vendor offer the software to customers. In one example, the developer administration functions include developer indicated terms and condition, licensing requirements, and/or technical information.

### EXAMPLE 5

Incorporating Software Functionality into an ASP Scenario

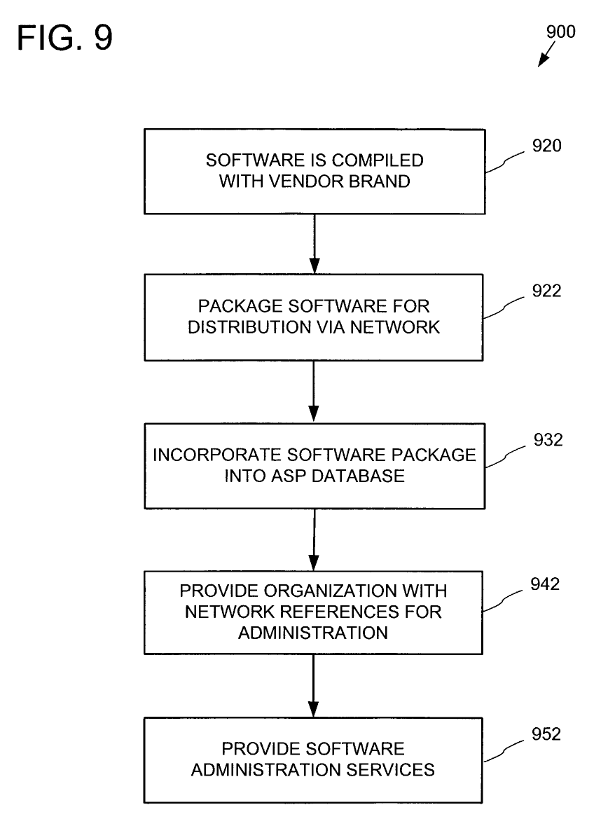

In some cases, it may be desirable to take an arbitrary piece of software and incorporate it into a system by which the software can be administered via an application service provider scenario. FIG. 9 is a flow chart showing a method 900 for accomplishing such an arrangement. The method 900 can be performed by the developer of the software or an entity specializing in application service provider scenarios which works in tandem with the software developer.

At 920, software is compiled with a vendor branding indication, so that when the software runs locally at an administered device, a window presented at an administered device, contains a vendor indication.

At 922, the software is packaged for distribution over a network. For example, software components and an installation program can be assembled into a package (e.g., according to the CAB file specification of Microsoft Corporation).

At 932, the software package is incorporated into a database maintained by the application service provider (e.g., the database 726 or 826). The software package itself may reside at a separate location, and a reference to the package can be incorporated into the database.

At 942, the organization wishing to avail itself of software administration via the application service provider scenario is provided with appropriate network references (e.g., URL's) by which the organization can access the application services for administering the software throughout its locations.

As described below, the network references can be sufficient for accomplishing administration via an application provider service scenario. For example, an administrator can configure a network so that software can be distributed as described herein via the network references. In this way, distribution of software via conventional media (e.g., diskettes or CD's) can be avoided.

At 942, software administration services are provided. For example, configuration directives can be collected via an application service provider scenario, and the directives can be implemented at associated nodes.

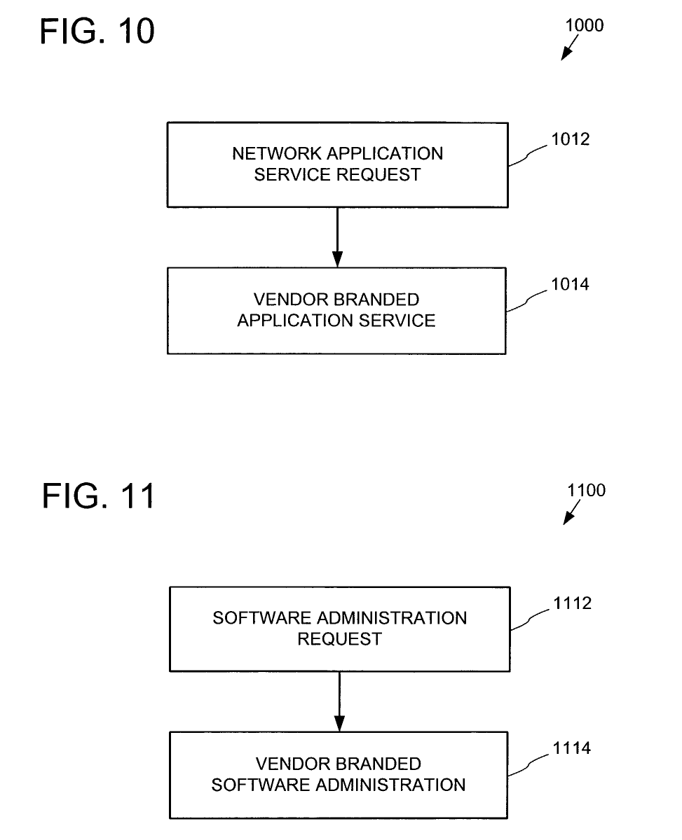

In another example, some portion or all of the administered software used by an administered device runs at the provider and the vendor-branded presentation is presented in a thin client (e.g., a web browser). In such a case, the administered device displays the branded presentation when an administered device displays a provider-hosted web site. FIG. 10 is a flow chart showing a method 1000 for accomplishing such an arrangement.

At 1012, an administered device user enters a network request for a provider-hosted vendor network resource. For example, the user could select a vendor domain name in a web browser (e.g., www.vendorname.com).

At 1014, the administered device displays on screen the vendor resource requested, including a vendor indication.

In one example, a provider-hosted vendor application services scenario supports administered software running locally at an administered device. In such a case, a second vendor may subsequently elect (if allowed by the appropriate developer or vendor) to offer the same administered software. In one such case, the described method 900 is used to prepare the administered software for the subsequent vendor.

### EXAMPLE 6

Software Administration Vendor Branding

As previously discussed, a vendor may offer software to a customer through a provider-hosted application services scenario. A customer administrator sets software administration directives used by the provider to determine application services provided at administered devices associated with the customer.

FIG. 11 depicts an exemplary method 1100 by which software administration is vendor-branded in an application service provider scenario.

At 1112, software administration services are requested by a customer administrator at a provider-hosted vendor network resource. For example, the user could select a vendor domain name or link in a web browser.

At 1114, the request returns a vendor-branded software administration resource.

### EXAMPLE 7

Anti-Virus Software Administration

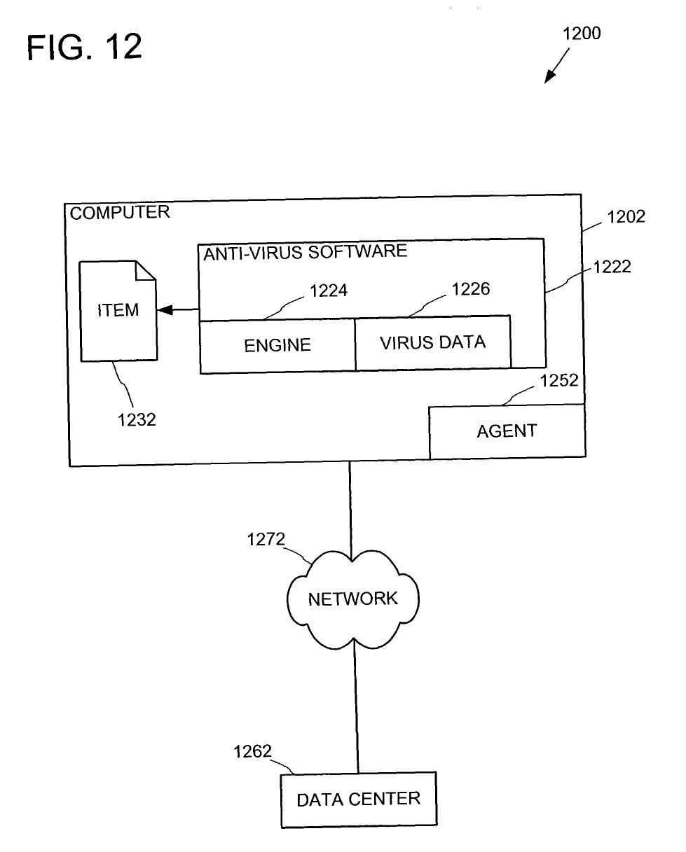

In any of the examples described herein, the software being administered can be anti-virus software. An exemplary anti-virus software arrangement 1200 is shown in FIG. 12.

In the arrangement 1200, a computer 1202 (e.g., a node) is running the anti-virus software 1222. The anti-virus software 1222 may include a scanning engine 1224 and the virus data 1226. The scanning engine 1224 is operable to scan a variety of items (e.g., the item 1232) and makes use of the virus data 1226, which can contain virus signatures (e.g., data indicating a distinctive characteristic showing an item contains a virus). The virus data 1226 can be provided in the form of a file.

A variety of items can be checked for viruses (e.g., files on a file system, email attachments, files in web pages, scripts, etc.). Checking can be done upon access of an item or by periodic scans or on demand by a user or administrator (or both).

In the example, agent software 1252 communicates with a data center 1262 (e.g., operated by an application service provider) via a network 1272 (e.g., the Internet). Communication can be accomplished via an HTTP-based protocol. For example, the agent 1252 can send queries for updates to the virus data 1226 or other portions of the anti-virus software 1222 (e.g., the engine 1224).

Configuration directives appropriate for anti-virus software include modifying the interval between querying for updates to the virus data 1226 and whether a user interface for the anti-virus software is hidden from the user at the computer 1202 on which the virus software runs. Hiding the user interface may be desirable because a user might not be interested in configuring or otherwise interacting with the anti-virus software until an infection is detected.

### EXAMPLE 8

Exemplary Plural Vendor-Branded Software

In one scenario, a provider HTTP server is used to provided plural vendor-branded application services in an application services provider scenario.

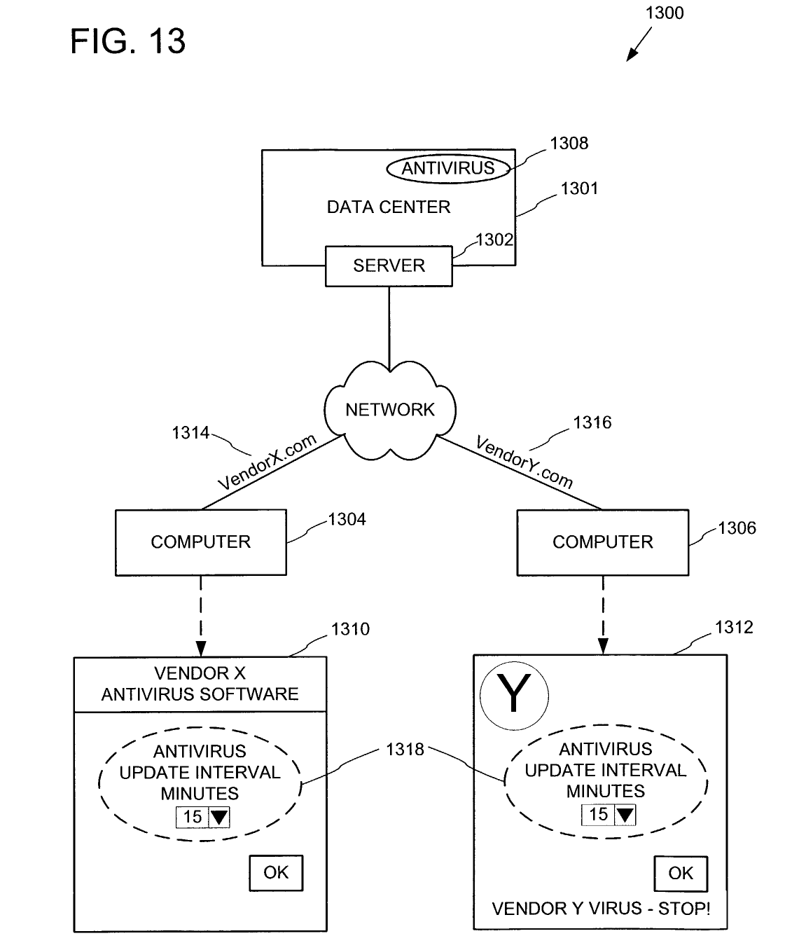

For example, in FIG. 13, a provider data center 1301 hosts application services for plural vendors. In this example, two vendors may offer applications services via a provider HTTP server 1302 to customers. As shown, one customer computer 1304 (e.g., a customer administrator client 732 (FIG. 7), or an administered device 760C (FIG. 7)) requests application services via a vendor domain link (e.g., vendorX.com) which resolves to the HTTP server 1302. The request can be generated in many ways not limited to a user selection of a graphical icon link or a textual link, or a resource request made by executing administered software. In this example, another computer 1306 requests application services via another vendor domain link (e.g., vendorY.com) which resolves the HTTP server 1302. In this example, in the case when a graphical window or other media presentation is generated at either of the computers 1304, 1306, in relation to the application services provided in response to the described request, the presentation includes a vendor presentation in accordance with the requesting computer's respective vendor domain link 1314, 1316.

In an example, two customer computers 1304, 1306, request a same type of application service (e.g., antivirus application services 1308). The request is made by each customer computer via different vendor domain links (respectively, 1314, 1316), that are resolved to the same provider-hosted server 1202. In this example, the same antivirus function 1318 is provided in response to the request. Although the provider provides the same service in this case, each customer terminal displays a different vendor presentation 1310, 1312 based on the provider-hosted vendor domain 1314, 1316 where the services were obtained. In this case, the same application services are plural vendor-branded.

In one implementation, the server can recognize which of the plural provider-hosted vendor domains it was called from using a virtual host protocol. For example, using an HTTP server protocol (e.g., NCSA HTTPd), different application services are provided to a customer from a provider, based on the named domain. In one case, after specifying other typical parameters in a “http.conf file,” the syntax depicted in Table 1, is used to resolve services to a virtual host. In this implementation, when the server is called using the local host, the server parses the conf/localhost_srm.conf file and sets the defaults accordingly.

TABLE 1

<VirtualHost 127.0.0.1>
ServerName localhost.vendorX.com
ResourceConfig conf/localhost_srm.conf
. . .
</VirtualHost>

### EXAMPLE 9

Exemplary ASP Using Directories

In one scenario, a provider HTTP server includes multiple directories in order to provide plural vendor-branded application services in an application services provider scenario.

In one example, directories are used to contain resources according to the types of software hosted by the provider. For example, directories B and C may contain antivirus resources, while directories D and E contain banking resources. In such a scenario, a customer computer network request accessing vendor offered provider-hosted antivirus application services would access the antivirus directories. In such a case, the customer computer network resource request would access an antivirus resource in directories B or C (e.g., vendorX.com/B/antivirus.asp, or vendorX.com/C/virusForm.html).

In a case when plural vendors are offering the same resource types (e.g., antivirus resources) in a provider-hosted application services scenario, the same directory resources could be used to support requests made by customers of plural vendors (e.g., vendorY.com/B/antivirus.asp, or vendorX.com/C/antivirus.asp). In such a case the request received would be resolved to a same resource even though serving the customers of several vendors. Other directory related resource requests would occur for multiple vendors of other software resource types (e.g., banking, at directories D and E).

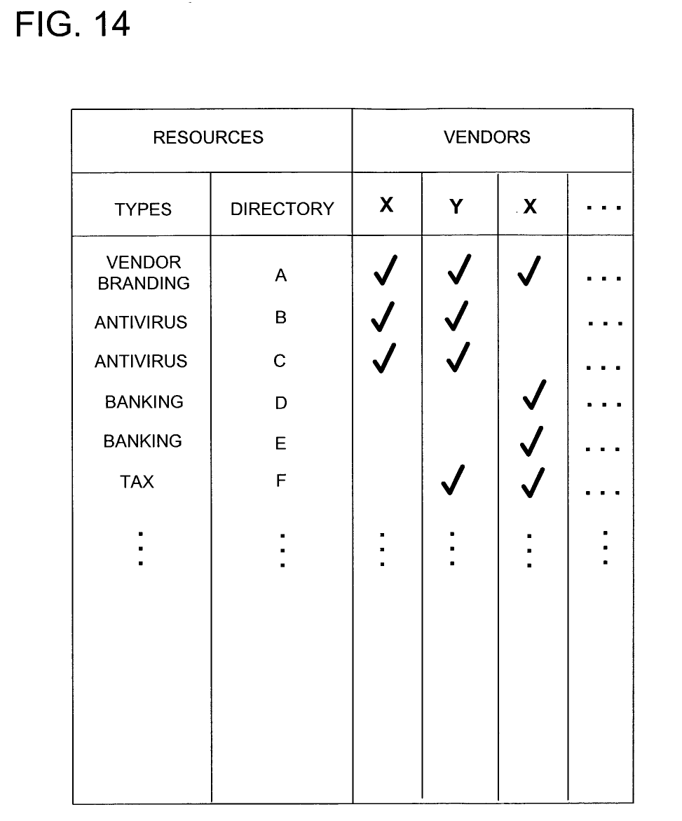

In another example, a provider data center has a web site with resources contained in plural directories (e.g., A, B, C, D, . . . Z). In one example, these directories contain resources that are used by the provider to host application services for the customers of multiple vendors. For example, given three vendors—X, Y, and Z, the resources could be kept in directories as shown in FIG. 14. In this example, the check marks indicate that vendor X is offering provider-hosted antivirus software resources contained in directories B and C to customers. Further, vendor Y is offering provider-hosted antivirus and tax software resources contained in directories B, C, and F, and vendor Z is offering provider-hosted banking and tax software resources contained in directories D, E, and F.

In such an example, a virtual directory (e.g., directory A) can be used to segregate vendor specific resources used for vendor branding. Such vendor branding resources would include such resources as vendor name, vendor trademark, vendor graphical look and feel elements, vendor sounds, vendor jpeg files, vendor contact information, vendor video or audio files. In one such example, resources requests including vendor presentations would include a path to the virtual directory. In such an example, resource requests made to virtual directory A (e.g., vendorX.com/A/sign_up.asp, or vendorY/A/sign_up.asp), would create different output depending on the identity of the vendor. The provider server would recognize the virtual directory request and resolve the request to a web page with a vendor specific presentation (e.g., FIG. 13, 1312, 1310). In view of the directory layout illustrated in FIG. 14, the resource requests shown in Table 2 would be resolved to the directory indicated in Table 2.

TABLE 2

| Resource Request | Directory | Resource |
|---|---|---|
| vendorX.com/B/antivirus.asp | B | antivirus.asp |
| vendorX.com/B/checkVirus | B | checkVirus |
| vendorX.com/A/signup.asp | virtualX | signup.asp |
| vendorY.com/B/antivirus.asp | B | antivirus.asp |
| vendorY.com/B/checkVirus | B | checkVirus |
| vendorY.com/A/signup.asp | virtualY | signup.asp |

In another example, a web page contained in a directory used by plural vendors (e.g., FIG. 14 B, C, D, E, F) contains a reference to a vendor specific resource contained in the virtual directory. For example, a request for a web page (e.g., vendorX.com/B/antivirus.asp) may itself include a reference to a virtual resource, which is resolved to a vendor specific resource based on the vendor domain identification as depicted in the web page request (e.g., vendorX.com).

In one implementation, the server can recognize which of the plural provider-hosted vendor virtual directories are required using a virtual directory protocol. For example, a NCSA HTTPd ScriptAlias directive can be used to set a virtual path. In one case, a script alias directive (e.g., “ScriptAlias virtual path”) creates a virtual directory on the provider server, so that any accesses to the named “virtual” directory will return an output from a server script contained at the named “path.” In such an example, the server would match the “virtual” name to the assigned “path” and access the desired resource.

### EXAMPLE 10

Vendor Branding with Active Web Pages

In one scenario, a provider server hosts active web pages in order to provide plural vendor-branded application services in an application services provider scenario.

For example, given a series of web pages which require vendor customization, each active web page performs a server look-up (e.g., in a database or other memory resource) in order to obtain and format the vendor presentation. In such a case, where the web page is a provider-hosted resource shared by plural vendors, the active web page resource obtains the vendor presentation and places it in the web page returned. Using this scenario, the provider is able to dynamically populate the page with the desired vendor presentation.

### EXAMPLE 11

Exemplary Business Models

In one scenario, a provider server provides vendors with provider-hosted business model selections in an application services provider scenario.

In one example, the provider hosts a series of web pages that vendors or prospective vendors can use to select a provider-hosted vendor business model. For example, a business model called “Small Business” includes a set of provider-hosted small business resources (e.g., a set of directories) that a prospective vendor selects to provide to potential customers. Such a “Small Business” business model includes a set of small business resources required by small business owners (e.g., accounting, tax, word processing, time scheduling, inventory management, etc.). Upon selecting the “Small Business” business model, the provider-hosted small business resources are offered by the vendor to potential customers. In one such example, the provider hosts plural “Small Business” model vendors using a set of directories common to the plural vendors, and a virtual directory used to provide a vendor branded presentation to each vendor's customers. In such an arrangement, a provider offers vendors plural kinds of provider-hosted business models (e.g., antivirus business models, tax business models, real estate salesperson business models, etc.) A vendor specializes and offers a business model to customers, while the provider handles the technical aspects of hosting the administered software for the customers generated.

In one such scenario, a provider hosts the vendor-branded business models using a file structure of shared resources and vendor-branded resources discussed in Example 9.

### EXAMPLE 12

Exemplary Vendor Branding or Origination

In one scenario, a provider server is used to provided vendor presentation resource management services and or vendor account initiation services in an application services provider scenario.

In one example, a vendor is given access to a directory containing vendor branding resources. In such a case, the vendor is allowed to freely change the vendor-branded resources. The vendor can for example, change at will any of the vendor indication or presentation resources. In order to facilitate such vendor freedom, in one example, the vendor can be given password protected read-write privileges for their vendor presentation resource directory. In this scenario, a vendor can change freely their look and feel, with little or no provider supervision.

In another scenario, a vendor traverses a series of provider-hosted web forms or control panels to manage vendor presentation resources. Such a series of web forms or control panel selections would provide better security and would a allow a vendor with a lower technology experience to traverse through a series of windows to manage vendor branding presentation. Such forms may include, templates for look and feel with color and texture selections, vendor executive photo submissions, vendor trademark submission, or any other vendor indication or presentations submission, configurations or management.

In another scenario, an entity interested in becoming a provider-hosted vendor traverses a series of provider-hosted web forms and or control boxes to originate a provider-hosted vendor account with the provider. Such a series of web pages and or control boxes optionally include a selection of software types available through the provider (e.g., from the provider, other vendors or developers) to offer to customers, an offer to upload software to offer to customers, administered software terms and conditions, an indication of whether uploaded software can be offered by the provider for marketing by other provider-hosted vendors, and such other vendor presentation configurations previously discussed.

### EXAMPLE 13

Information Segregation

In one scenario, a provider data center is used to provided information to vendors, customers, or developers in an application services provider scenario. Customers desire information about software administration and configuration of administered devices in that customers network. Vendors desire information about their customers, software administered for their customers (including revenue information if handled by the provider for the vendors), software available for offering to their customers, and provider-hosted vendor related web site activity (e.g., number of web page hits, etc.). Developers desire information about software uploaded by the developer to the data center which is offered by the developer to vendors for provider-hosted vendor marketing, including revenue information if handled by the provider. In such a scenario, vendors, customers, or developers are provided only limited access to information in the data center.

In one example, when a web page is requested, the server is able to limit provided information based on the domain name contained in the resource request (e.g., vendorX.com, vendorY.com, vendorZ.com). In one such case, a host name is used to map the request to an internal database identifier, that is used to restrict queries made on a database. For example, given the requested resource “vendorX.com/B/customerNameSearch/ . . . ,” a vendor requesting a customer search is identified from the host name “vendorX” and a subsequent database query includes an added search term limiting the search to customers of vendor X (e.g. “vendor=32756”). A table mapping vendor domain names to unique vendor identifiers can be retained in memory to speed the processing time. Using this method, an added search term limits the information obtainable in a database query.

In another example, customized views are provided for each vendor, customer, or developer. A customized view includes an explicit query limitation that automatically appends the desired database query limitation to each database query. One advantage of views is that the explicit query limitation is issued through the provided view, however, this technique may not be as scalable because views are necessary for each vendor, customer, and developer.

### EXAMPLE 14

Information Segregation by Associations

In one scenario, a provider data center is used to provided information to vendors, customers, or developers in an application services provider scenario. The data center includes one or more databases that contain one or more relationships or associations.

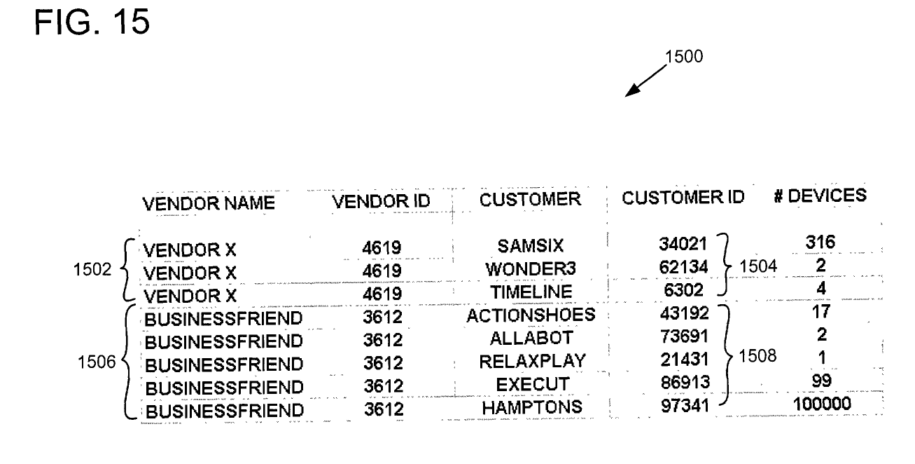

For example, a database contains an association between customers and vendors. In other examples, one or more databases contains associations between customers and vendors, vendors and developers, developers and software, customers and administered devices, or administered devices and administered software. In one scenario, a customer-vendor association helps limited the access a vendor has to customer information. In one example, these associations are provided by database tables. As shown in FIG. 15, a database query from vendor X 1503 contains a search term limitation (e.g., “VendorID=4619”) and accesses only information about customers associated with vendor X (e.g., 1504). A database query from vendor “Business Friend” 1506, contains a search term (e.g., “VendorID=3612”) and accesses only information about customers associated with Business Friend (e.g., 1508).

In another example, an association between customers and administered devices is used to limit what administered devices a customer is able to configure. In another example, an association is used to limit what administered software an administered device is able to obtain or utilize. In another example, an association is used to limit what software a developer is able to obtain information about.

In a first implementation, a single database holds all vendor and client information. In another implementation, a separate database is created at the data center for each vendor. In another implementation, a separate database is created at the data center for each customer. Using these separate database scenarios often are not as desirable because it is more difficult for the provider to obtain enterprise wide information about the providers business across many customers or many vendors. However, for some sensitive customers or vendors (e.g., governments or sensitive industries), it may be required or requested by the vendor or customer.

### EXAMPLE 15

Revenue Database

In one case, a database supports customer and vendor revenue information. In another case, a database supports vendor and developer revenue information. In another case, a database supports developer and provider revenue information. In another case, a database supports information about vendor and provider information. In any such case supporting revenue information, a database may also support revenue collection or automated revenue collection. As before, a single or multiple databases may be used, and information is available only to parties to a revenue relationship.

### EXAMPLE 16

Cookies

Several ways of identifying network requests have been described in this document. However, this does not mean that in some cases Cookie data structures are not used to identify requests received at the data center. For example, Cookies may be used to identify administered devices, customer client computers used for customer administration, vendor client computers, developer client computers, agent client computers, or other client computers. In other cases, a client computer logs on (e.g., using a password) and starts a session.

### EXAMPLE 17

Customer Branding, Developer Branding, or Provider Branding

In some cases, a customer will prefer to have an application service customer-branded. For example, when the customer is a school, government agency. It may also be desired by a customer who is providing network services to third parties or there own customers. In such a case, a customer may request, and a vendor may agree to allow customer vendor branding. There may also be cases where provider branding or developer branding is requested. In any such case, the same system discussed is used to provide the requested branding. This is accomplished with a customer administration form, a vendor form, or a developer form (e.g., web page).

### EXAMPLE 18

Exemplary Implementation

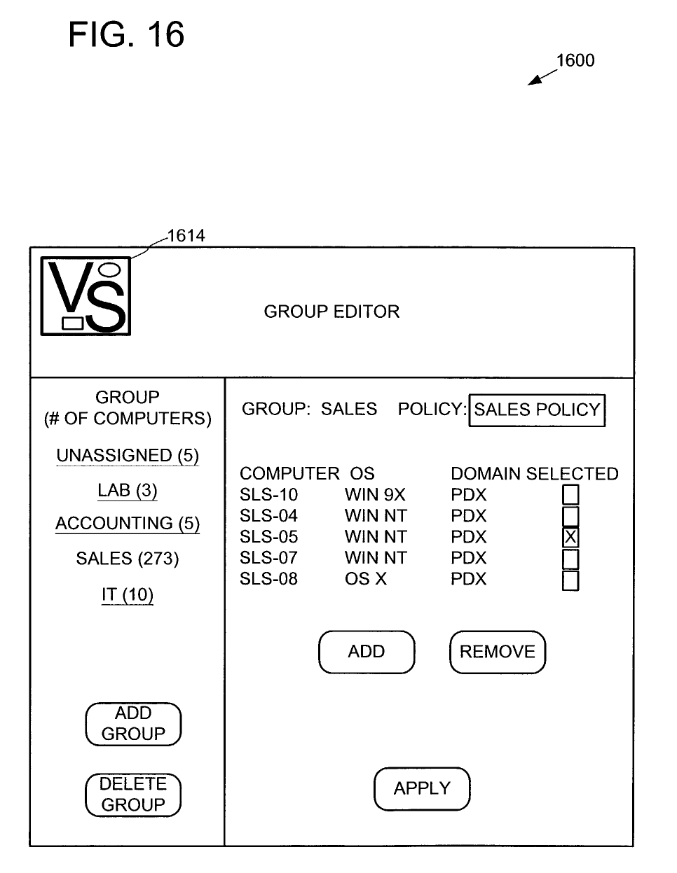

FIGS. 16-20 are screen shots illustrating an exemplary implementation related to the above technologies. The screen shots show a user interface as presented by a web browser such as the Microsoft Internet Explorer software, which is marketed by Microsoft Corporation. Other software can be used, and either Internet (e.g., http://www.sitename.com/xyz.asp) or intranet (e.g., http://subnet.companyname/xyz.asp) references can be used to acquire the user interfaces. The illustrated user interface can be provided by any number of software packages, including a server-side scripting environment (e.g., Microsoft active server pages technology) associated with a web server.

To acquire access to the application services, an organization can enter into a contractual arrangement with an application service provider vendor (e.g., by subscribing to the services and agreeing to pay a monthly fee). The application service provider can provide an appropriate network link and a user name and password by which an administrator can log into the system and begin administering the software.

As described above, an administrator can acquire an installation utility and remotely deploy agent software to the nodes to be administered. The administrator can then go about the process of configuring how the nodes are to be administered.

During the process, it may be desirable to place one or more nodes into a group. FIG. 16 shows a screen shot 1600 depicting an exemplary user interface (including a vendor-branded presentation 1614) for manipulating groups. A database of configuration information can be adjusted according to the administrator's selections.

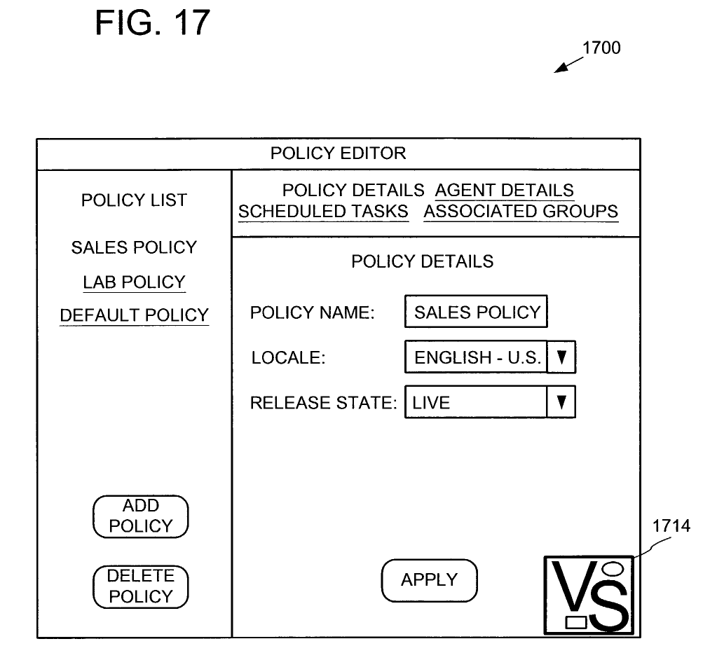

It may also be desirable to place one or more configuration directives into a named set (e.g., a policy). Such a named set can then be assigned to a group as shown in FIG. 17, which shows an exemplary user interface 1700 (including an exemplary vendor brand 1714) for manipulating policies. One directive of the policy (i.e., “Release State”) relates to the stage of the software to be distributed for the group. The stage can be specified as “Beta,” “Early,” or “Live.”

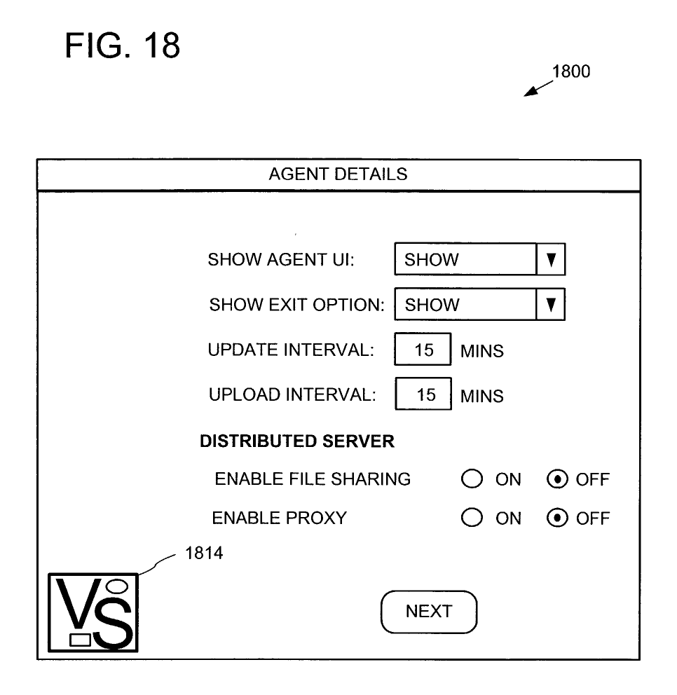

The configuration directives can take many forms. For example, FIG. 18 shows an exemplary user interface (including an exemplary vendor indication 1813) for manipulating configuration directives related to an agent. Changes by an administrator are stored in a configuration database, and agents assigned the related policy are updated accordingly (e.g., when they contact the application service provider data center). The user interface for the administered software can be hidden via the options (e.g., “Show Agent UI”). Also, as shown, an option “Show Exit option” can be used to control whether an icon appears in an icon menu by which a user can exit the software running at a node.

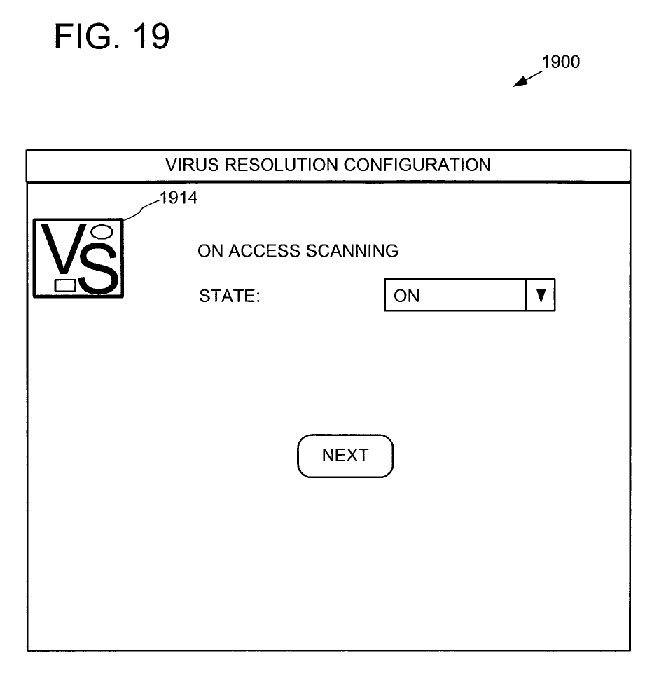

Other configuration directives are possible. FIG. 19 shows a configuration directive related to whether on-access scanning is enabled and includes an identification of the vendor 1914.

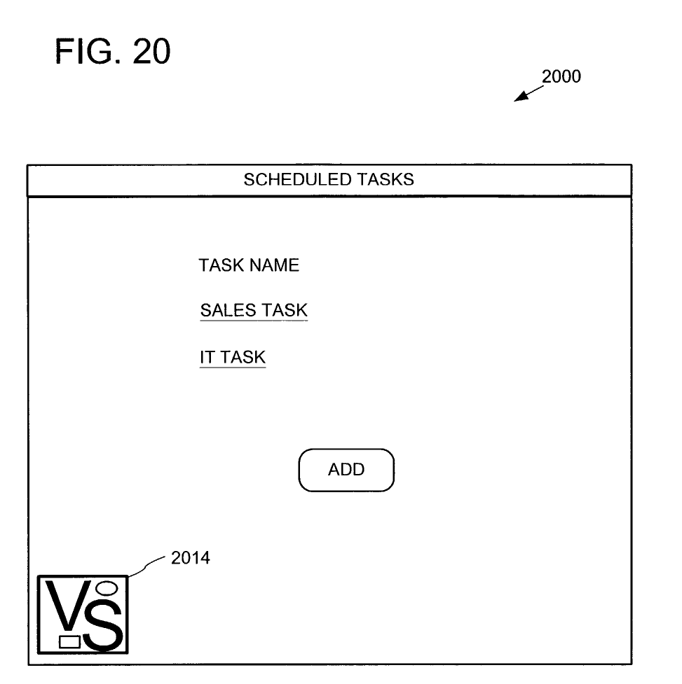

In addition, tasks can be scheduled for policies. For example, FIG. 20 is a screen shot showing an exemplary user interface 2000 (including vendor presentation 2014) by which an administrator can schedule tasks. Additional user interfaces can be presented by which tasks can be added and task recurrence can be specified. Additional recurrence parameters can be specified by another user interface (e.g., whether to occur every day or recur every n days, whether to recur indefinitely or n times, and whether to use default advanced settings, such as a jitter value, late limit, and maximum duration parameters). Alternatively, a task can be scheduled for a group.

Various other user interfaces can be presented. For example, a list of computers can be presented (e.g., indicating a computer name, domain, operating system, and group). Although these example, interfaces represent software administration application services, it is readily apparent how these vendor indications are perceived at locally run software or other application services.

Software administration will proceed according to the configuration specified via the user interfaces. For example, if a group of computers has been assigned the “Beta” stage, upon availability of a software release associated with the “Beta” stage, queries from agents for appropriate software will be answered by providing a list including software of the “Beta” stage.

For example, agent software at a node can send an HTTP-based request to a data center, providing a node identifier unique to the node. In response, the data center can provide a list of software based on the configuration information specified by the administrator.

The agent software can then acquire the software it needs to conform with the configuration information specified by the administrator. In this way, automatic software distribution via configuration directives can be accomplished.

When a new release becomes available (e.g., a software development team releases software), it can be added to an appropriate database with a reference indicating a location from which the release can be obtained. Subsequent queries from agents receive replies taking the new release into account. The software will thus percolate down to the agents as they request it. If a node is off-line (e.g., a mobile user having a computer not connected to a network), there may be some lag time, but upon connecting to the network, the agent can query the data center and an appropriate software list can be provided.

In the example, the list of software can be a list of files conforming to the CAB file specification of Microsoft Corporation. If software administered by the system is installed but not listed in the list, the software is uninstalled. The CAB file may remain on the node so that another node can access it (e.g., in a peer-to-peer arrangement).

At some point, the software life cycle may begin again or move to an earlier stage in some other way. In such a case, beta versions of the software will be distributed to those nodes associated with a group that is associated with a policy specifying beta software.

In this way, software administration can be accomplished via an application service provider scenario. Although administration can include a wide variety of functions, the illustrated example enables monitoring (e.g., for producing reports of virus infection), configuration, and installation of software. In addition, the polled pull scenarios described can allow the system to operate even though there may be a firewall in place. Thus, application administration can be performed in such a way that software is automatically updated through a firewall. Such an arrangement can provide a valuable service in many situations, such as for a large enterprise's information technology department. Such an enterprise may have 10, 100, 1000, 10,000, 100,000, or more nodes.

Because more than one such enterprise can be served in an application service provider scenario, 10,000, 100,000, 1,000,000, 10,000,000, or more nodes can be administered by the described technologies.

### EXAMPLE 9

Database Schema

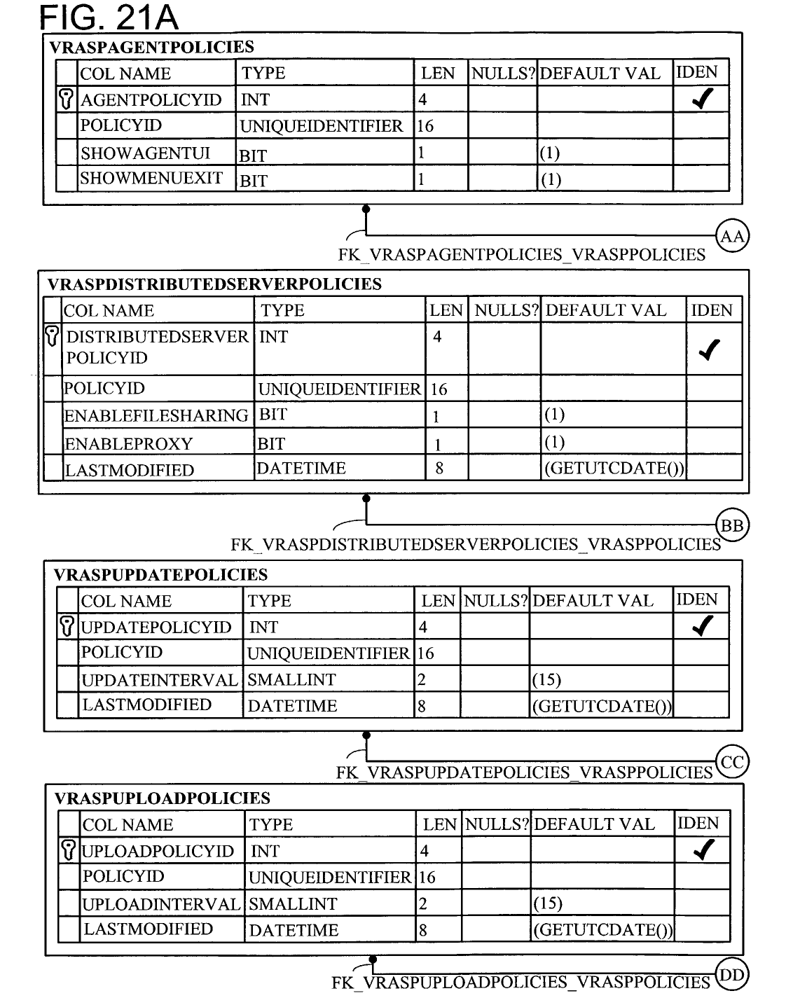

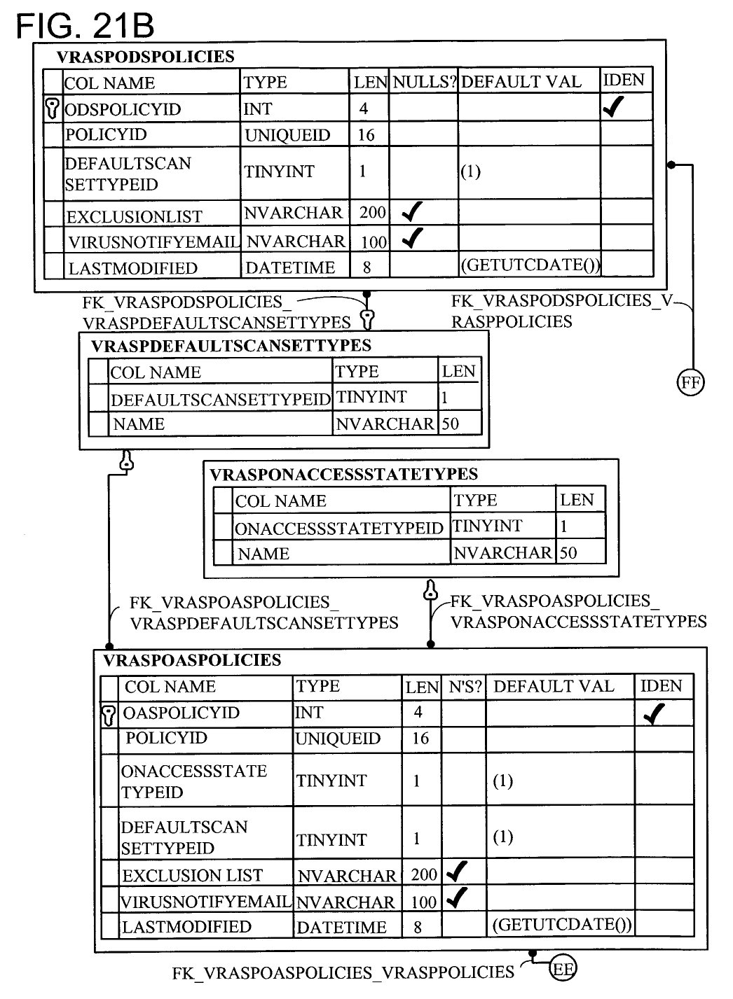

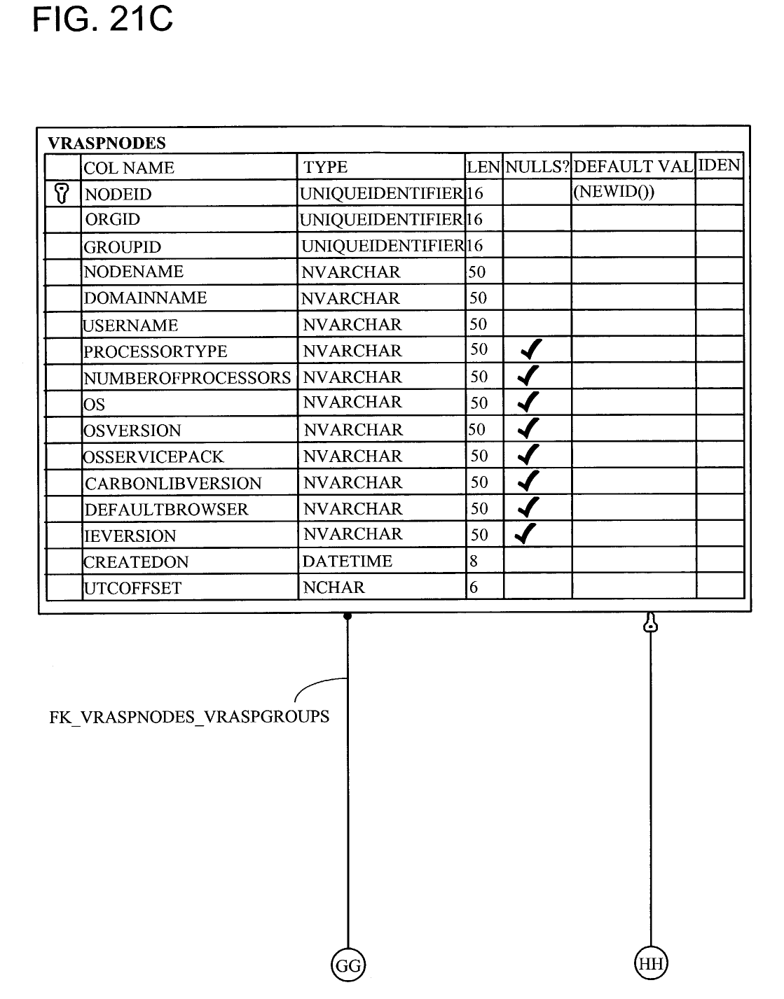

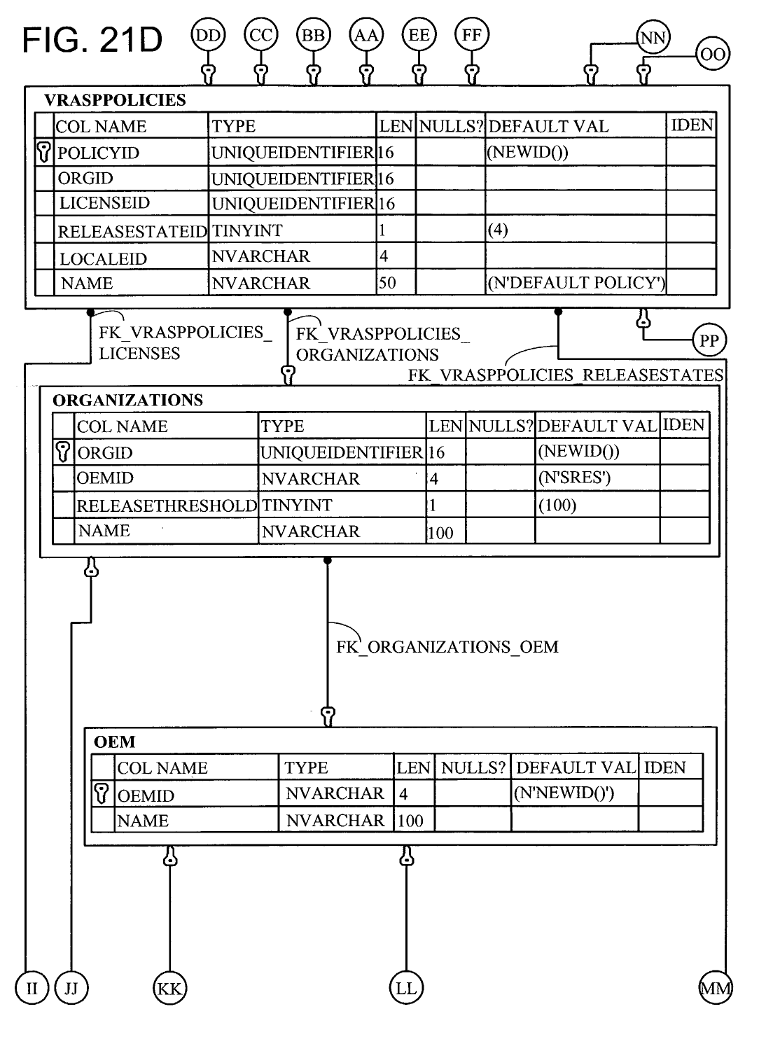

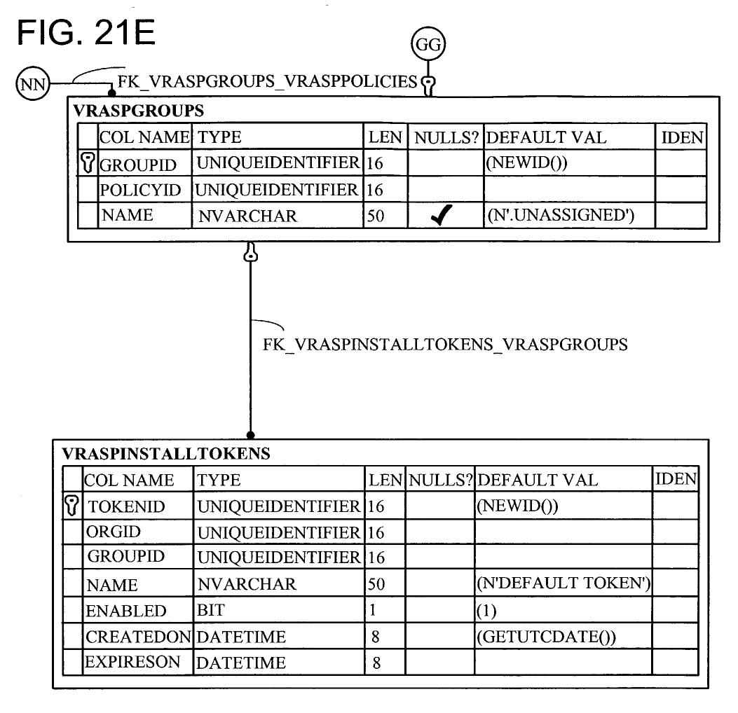

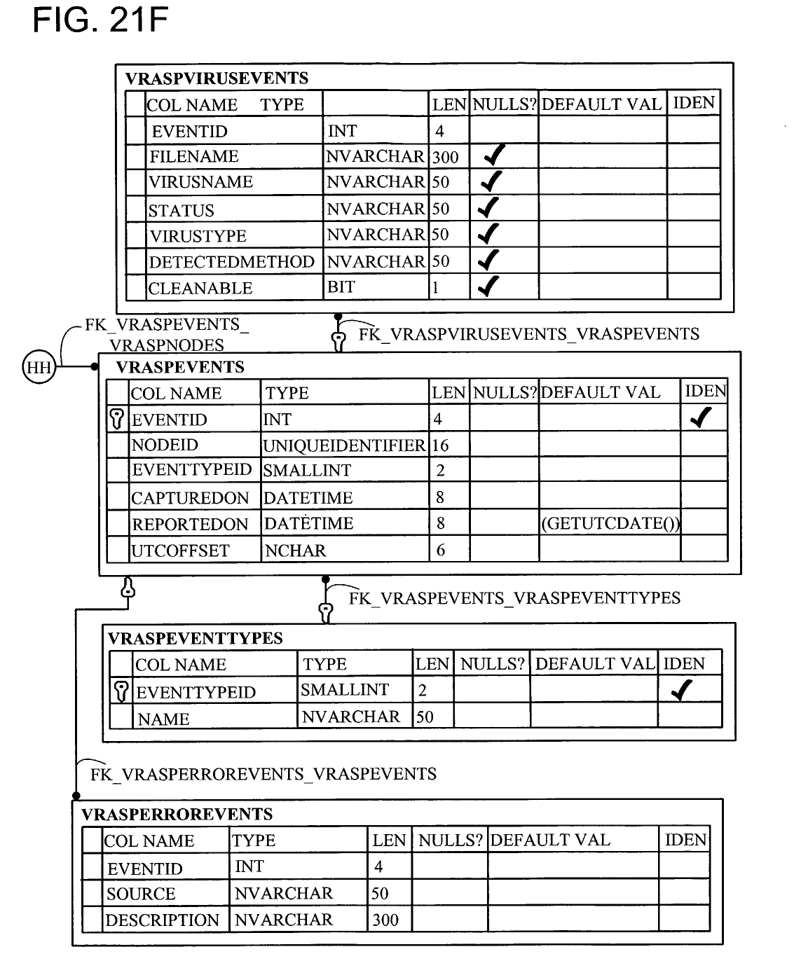

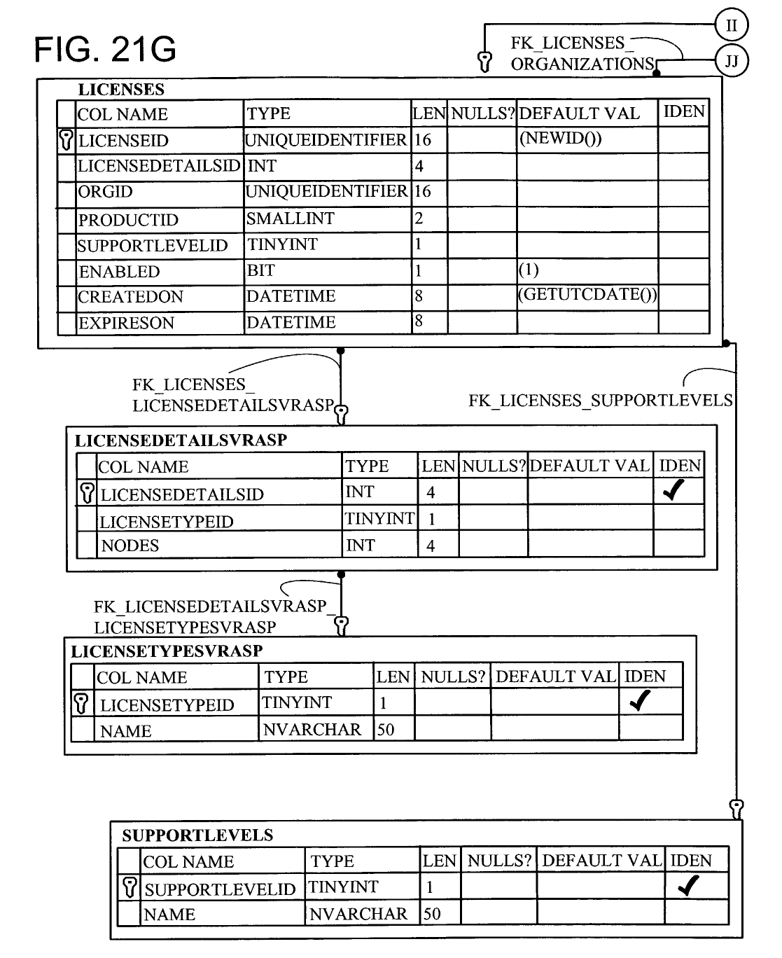

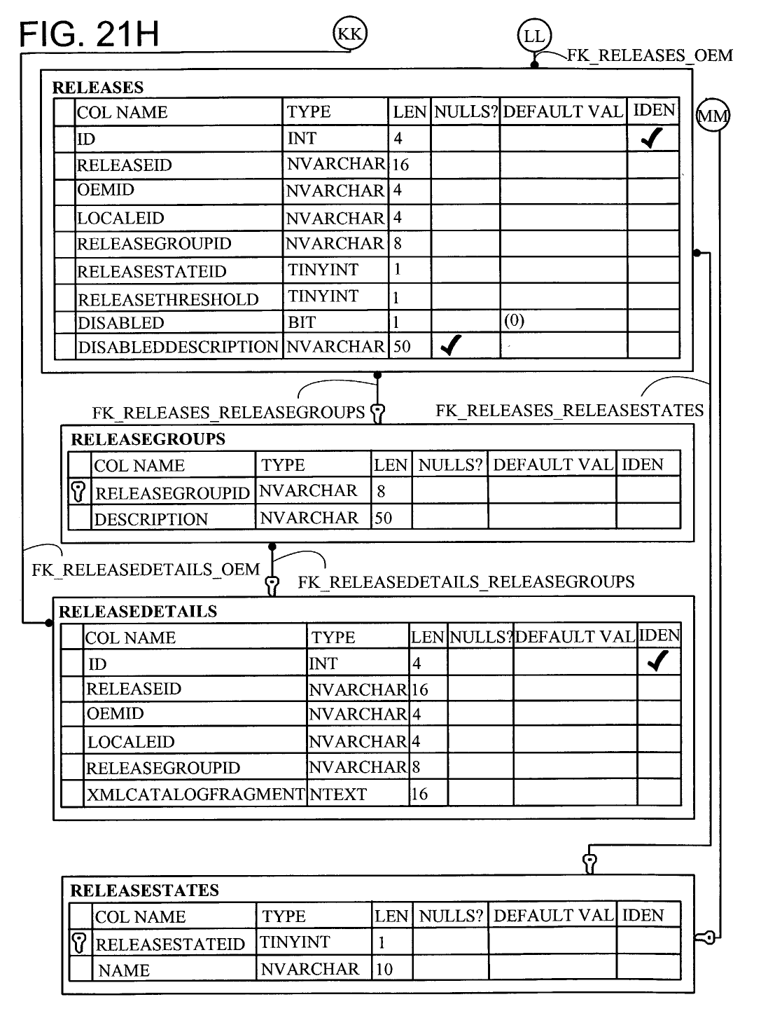

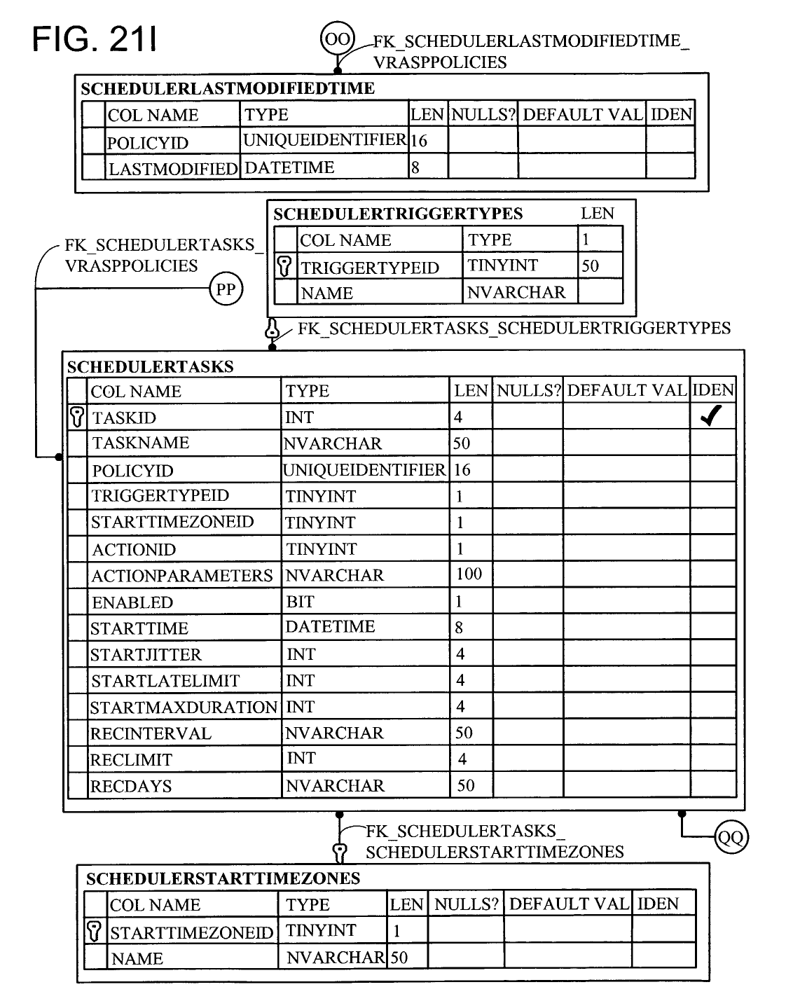

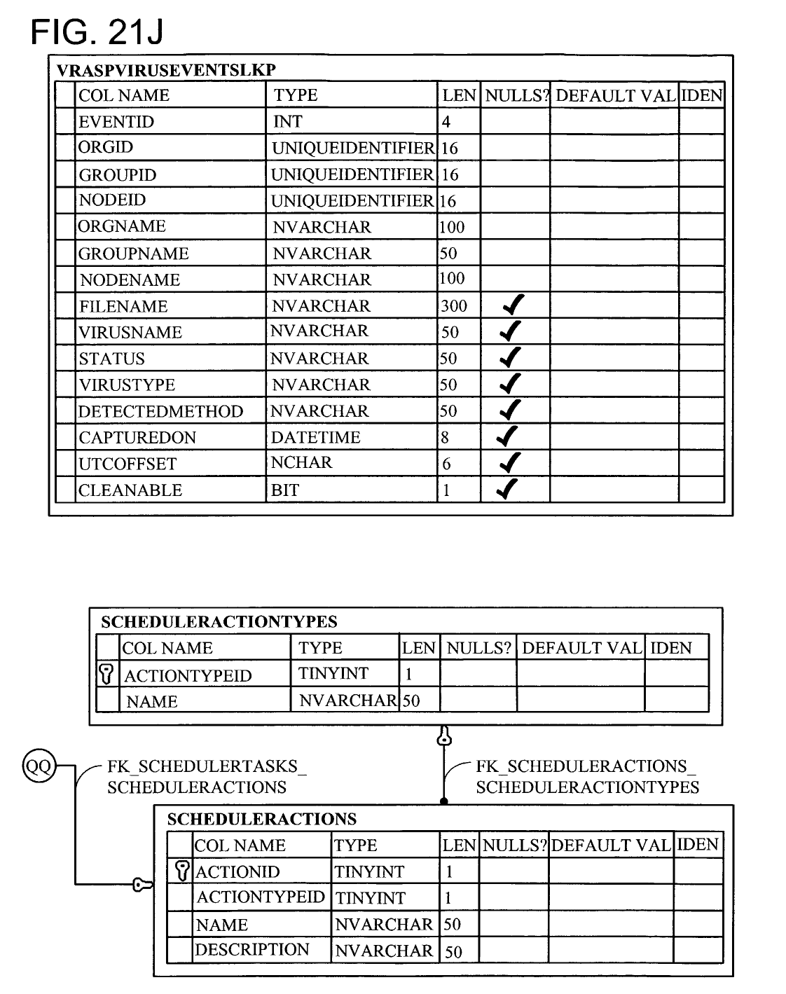

FIGS. 21A-J show an exemplary database schema for implementing software administration via an application service provider scenario.

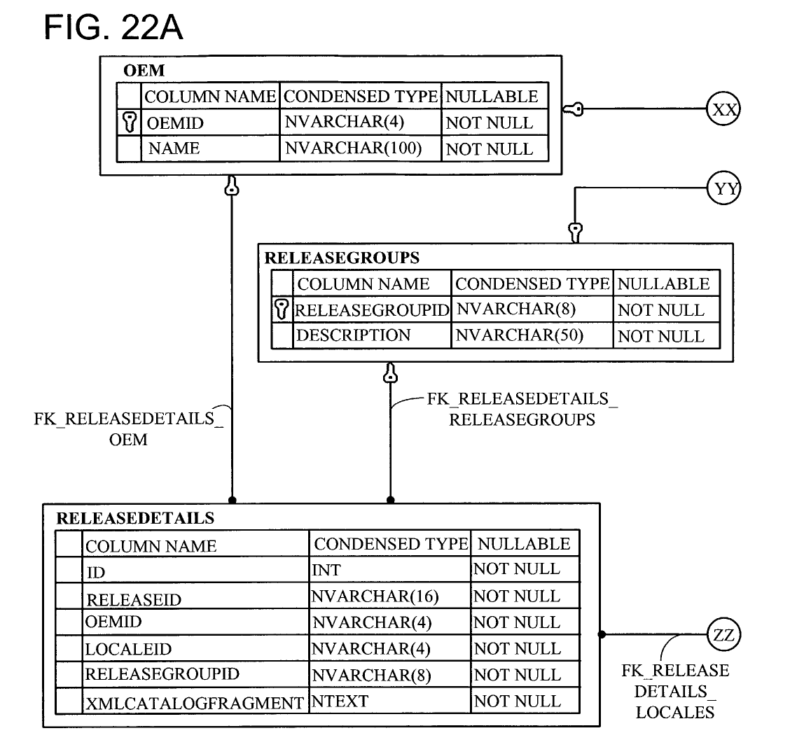

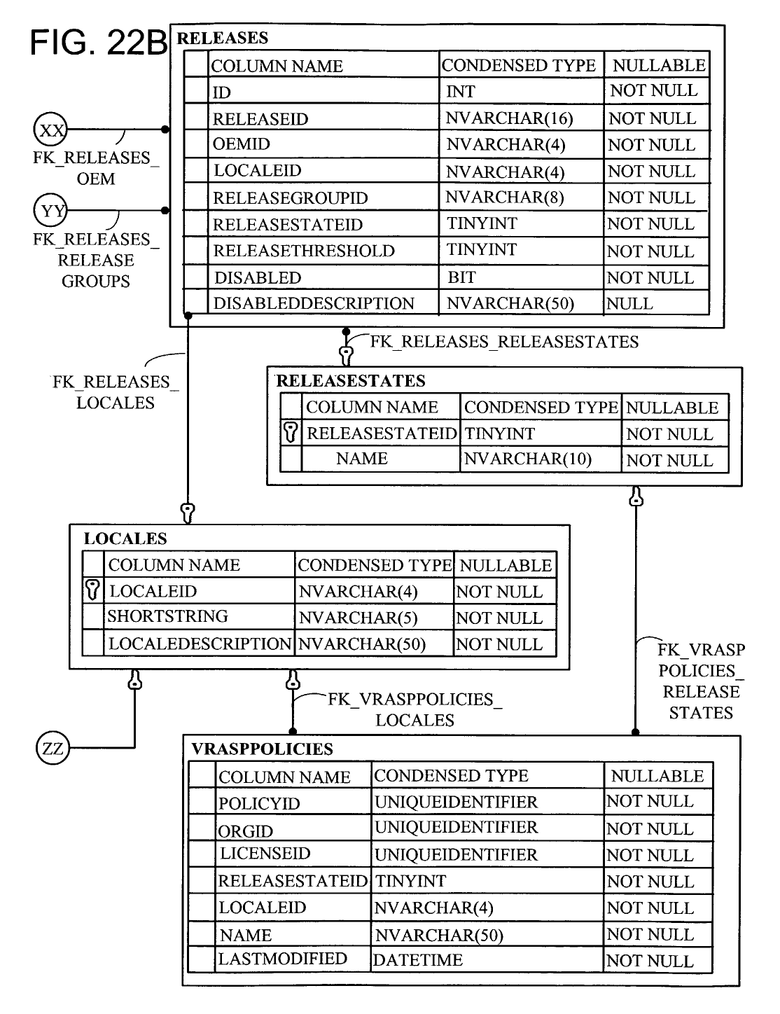

FIGS. 22A-B show another exemplary database schema for implementing software administration via an application service provider scenario.

The schema are examples only. A wide variety of other arrangements are possible, and another approach (e.g., XML) can be used. This example is of a database schema for a single vendor. Using this example, to obtain a plural vendor configuration, a separate database would be opened at the data center for each vendor.

### Alternatives

Having described and illustrated the principles of our invention with reference to illustrated embodiments, it will be recognized that the illustrated embodiments can be modified in arrangement and detail without departing from such principles. It should be understood that the programs, processes, or methods described herein need not be related or limited to any particular type of computer apparatus. Various types of general purpose or specialized computer apparatus may be used with, or perform operations in accordance with, the teachings described herein. Elements of the illustrated embodiment shown in software may be implemented in hardware and vice versa.

Technologies from the preceding examples can be combined in various permutations as desired. Although some examples describe an application service provider scenario, the technologies can be directed to other arrangements. Similarly, although some examples describe anti-virus software, the technologies can be directed to other arrangements.

In view of the many possible embodiments to which the principles of our invention may be applied, it should be recognized that the detailed embodiments are illustrative only and should not be taken as limiting the scope of our invention. Rather, we claim as our invention all such embodiments as may come within the scope and spirit of the following claims and equivalents thereto.

We claim:

1. A computer-implemented method of providing singularly hosted, customer administered, plural vendor-branded distribution of locally run software, the method comprising:
providing by a network accessible host, a data center including plural vendor-branded software for distribution over a network;
receiving a network request at the host, from an administered device associated in the data center with a customer identifier;
distributing software to the administered device, the software containing a branding presentation of a vendor associated in the data center with the customer identifier.

2. The method of claim 1 further comprising:
receiving a network request at the host, from another administered device associated in the data center with another customer identifier;
distributing software to the other administered device, the software containing a branding presentation of another vendor associated in the data center with the other customer identifier.

3. The method of claim 1 wherein the software distributed to the administered device and the other administered device, is a same application service.

4. The method of claim 1 further comprising:
receiving a network request at the host, from a client computer associated in the data center with the client identifier; and
returning to the client computer, a software administration resource containing a branding presentation of the vendor.

5. The method of claim 1 wherein the vendor branding contained in the distributed software is determined from a host name contained in the request.

6. The method of claim 1 wherein the vendor branding contained in the distributed software is determined from an association in a table at the data center.

7. A computer-implemented application services provider method for hosting plural application service packages for plural application services provider vendors, the method comprising:
providing a data center including plural hosted application service packages;
receiving at the data center, a software administration directive for a first administered device associated with a first customer, the software administration directive identifying at least two application service package selections for the first administered device;
receiving at the data center, a software administration directive for a second administered device associated with a second customer, the software administration directive identifying an application service package selection for the second administered device;
receiving a network request at the data center from the first administered device;
providing a vendor-branded application service to the first administered device;
receiving a network request at the data center from the second administered device; and
providing a vendor-branded application service to the second administered device;
wherein the vendor-branded application service provided to the first and second administered devices contain different vendor brands.

8. The method of claim 7, wherein the at least two application service package selections are for different types of software.

9. The method of claim 7, wherein the at least two application service package selections are selected from plural available package selections from a business model.

10. The method of claim 7, further comprising:
receiving at the data center, a vendor request for customer information;
verifying an association between a vendor identified from the request and the first customer;
obtaining information from the data center about the first customer including package selections for the first administered device; and
providing the obtained information in response to the vendor request.

11. The method of claim 7, further comprising:
receiving at the data center, a customer request for information;
verifying an association between a customer identified from the request and the first administered device;
obtaining information from the data center including package selections for the first administered device; and
providing the obtained information in response to the customer request.

12. A system for providing multiple vendor offered singularly hosted application services comprising:
a data center including,
a network server using directories to provide application services to customers, including directories with common resources and directories including vendor-branded resources including,
a vendor-branded customer resource for software administration of customer administered devices;
plural vendor-branded application service resources including resources that run locally at customer administered devices;
a resource for supplying information to a vendor about the vendors associated customers; and
a database including associations between vendors and customers.

13. The system of claim 12 wherein the database includes associations between customers and administered devices, and associations between administered devices and administered software.

14. The system of claim 12, wherein the directories include a resource for a vendor to select application services to be provided by the vendor via the data center.

15. The system of claim 12, wherein the directories include a resource for a software developer to offer application services that a vendor can offer to the vendors clients to vendors.

16. The system of claim 12, wherein the directories include resources for vendors and customers to obtain information contained in the database.

17. The system of claim 12, wherein the data center includes a resource for compiling a software package with a vendor branding resource upon receiving an indication from a vendor to provide application services including the software package to customers of the vendor.

18. The system of claim 12, wherein the directories include a resource for initiating a new vendor account, including obtaining vendor presentation resources from the vendor.

19. The system of claim 12, wherein the directories include a vendor-branded resource for initiating a new customer account, including an initial selection of application services.

20. The system of claim 12, wherein the vendor-branded customer resource for software administration of customer administered devices includes control panel for selecting which application services are available to a specific administered device.

21. The system of claim 12, wherein the system administers software at 1,000,000 or more administered devices.

22. The system of claim 12, wherein the system administers software at 10,000,000 or more administered devices.

23. The system of claim 12 further wherein the data center includes a resource wherein a software developer uploads software to the data center and offers the software for certain terms and conditions.

24. A memory for storing software for execution by a network server to perform a computer-implemented method of providing singularly hosted, customer administered, plural branded distribution of locally run software, the memory comprising:
code for providing by a network accessible host, a data center including plural branded software for distribution over a network;
code for receiving a network request at the host, from an administered device associated in the data center with a customer identifier; and
code for distributing software to the administered device, the software containing a branding presentation of associated in the data center with the customer identifier.

25. The memory of claim 24 further comprising code for providing vendor browsing of customer information for customers associated at the data center with a vendor.

26. The memory of claim 24 wherein the branding presentation identifies a customer.

27. The memory of claim 24 wherein the branding presentation identifies a vendor.

28. The memory of claim 24 wherein the branding presentation identifies a developer.

29. The memory of claim 24 wherein the branding presentation identifies a provider.

30. The memory of claim 24 wherein the branding presentation identifies two entities, at least one being: a vendor, a provider, a customer, or a developer.
